(19) United States
(12) Patent Application Publication
(10) Pub. No.: US 2004/0219978 A1
(43) Pub. Date: Nov. 4, 2004

(54) Image generation method, program, and information storage medium

(75) Inventors: Hideo Teramoto, Yokohama-shi (JP); Kazuhito Bando, Kawasaki-shi (JP)

Correspondence Address: OLIFF & BERRIDGE, PLC, P.O. BOX 19928, ALEXANDRIA, VA, 22320, US

(73) Assignee: NAMCO LTD., Tokyo (JP)

(21) Appl. No.: 10/680,186

(22) Filed: Oct. 8, 2003

(30) Foreign Application Priority Data
Oct. 9, 2002 (JP) 2002-295924

(51) Int. Cl. A63F 13/00

(52) U.S. Cl. 463/32; 463/33; 463/6

(57) ABSTRACT

A value of a first parameter (pressure parameter) is changed when moving objects OB1 and OB2 have been in an approach relation (pressure relation), and an action change event (such as spin or course out) is generated when a value of the first parameter reaches a threshold value. The approach relation is determined based on the time difference between the moving objects OB1 and OB2. A parameter display object POB (pressure meter) which visually indicates the change in the value of the first parameter is displayed. The parameter display object is displayed associating with each of a plurality of moving objects. The threshold value and the change rate of the first parameter value are set for each of the moving objects. The first parameter is reset when the moving objects OB1 and OB2 are in a non-approach relation.

Japanese Patent Application No. 2002-295924 filed on Oct. 9, 2002, is hereby incorporated by reference in its entirety.

### BACKGROUND OF THE INVENTION

The present invention relates to an image generation method, a program, and an information storage medium.

Conventionally, an image generation system (game system) which generates an image viewed from a given viewpoint (virtual camera) in an object space, which is a virtual three-dimensional space, is known. Such an image generation system is very popular as a system which enables experience of so-called virtual reality. Taking an image generation system which allows a competitive game (car game) to be enjoyed as an example, a player enjoys the game by operating a moving object (player's moving object or player's car) by using an operating section (steering wheel, shift lever, accelerator pedal, brake pedal, and the like), and competing with a moving object (other player's moving object or other car) operated by another player (computer player or other human player). An image generation system disclosed in Japanese Patent Application Laid-open No. 11-137843 is known as such an image generation system.

However, the influence of a psychological factor such as pressure on the game is not taken into consideration in a conventional competitive game. Therefore, since the psychological warfare factor which plays an important role in competition is not taken into consideration, direction of a human and emotional game cannot be realized, whereby player's satisfaction level with virtual reality cannot be increased.

In this case, the distance between the computer car operated by a computer and the player's car operated by the player or the period of time in which the distance is maintained may be measured, and pressure may be applied to the computer car, for example.

However, this method causes pressure to be always applied to the computer car at a constant distance irrespective of the course configuration such as a curve or straight section, whereby production of a game which satisfies the player cannot be realized.

### BRIEF SUMMARY OF THE INVENTION

One aspect of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

determining that the first and second moving objects have been in the approach relation when a time difference between the first and second moving objects becomes smaller than a given set time difference.

Another aspect of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

resetting or decreasing the value of the first parameter of the second moving object which has changed due to the approach relation, when the first moving object is positioned outside first and second distance ranges which are set in front of and behind the second moving object, respectively, and leaving the value of the first parameter unchanged when the first moving object is positioned in the first distance range which is set in front of the second moving object.

A further aspect of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

changing the value of the first parameter of the second moving object at a higher change rate as a distance between the first and second moving objects increases in a direction which intersects a traveling direction at right angles when the first moving object is positioned in a third distance range which is set behind the second moving object.

A still further aspect of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

performing processing of displaying a parameter display object which visually indicates a change in the value of the first parameter of the second moving object.

A yet further aspect of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation; and

performing processing of displaying a parameter display object which visually indicates a change in the value of the first parameter of the second moving object.

### BRIEF DESCRIPTION OF THE SEVERAL VIEWS OF THE DRAWING

FIG. 1 is a functional block diagram of an image generation system in an embodiment of the present invention.

FIGS. 2A to 2D are illustrative of a parameter change method.

FIGS. 3A and 3B are illustrative of a player display object.

FIGS. 4A and 4B are illustrative of a setting method of a threshold value and a change rate.

FIGS. 5A and 5B are illustrative of a setting method of a threshold value and a change rate.

FIGS. 6A and 6B are illustrative of a reset method of a parameter value.

FIGS. 7A to 7D are illustrative of determination of an approach relation taking speed into consideration.

FIGS. 8A and 8B are application examples of various games.

FIG. 9 is illustrative of a time difference.

FIGS. 10A to 10D are illustrative of a determination method of an approach relation based on a time difference.

FIGS. 11A and 11B are illustrative of a method in which a parameter value is not changed up to a threshold value when the distance between moving objects is large.

FIGS. 12A to 12D are illustrative of a method of setting distance ranges in front of and behind a moving object.

FIGS. 13A to 13D are illustrative of a method of changing a change rate of a pressure parameter corresponding to a moving distance in the transverse direction.

FIG. 14 is a flowchart example of processing in an embodiment of the present invention.

FIG. 15 is a flowchart example of processing in an embodiment of the present invention.

FIG. 16 is a flowchart example of processing in an embodiment of the present invention.

FIG. 17 is a flowchart example of processing in an embodiment of the present invention.

FIG. 18 is a flowchart example of processing in an embodiment of the present invention.

FIG. 19 is a flowchart example of processing in an embodiment of the present invention.

FIGS. 20A to 20D are illustrative of processing in an embodiment of the present invention.

FIG. 21 is a hardware configuration example.

FIGS. 22A to 22C are system examples of various forms.

### DETAILED DESCRIPTION OF THE EMBODIMENT

Embodiments of the present invention are described below with reference to the drawings. Note that the embodiments described hereunder do not in any way limit the scope of the invention defined by the claims laid out herein. The entire configuration described below is not necessarily an indispensable requirement for the present invention.

1. Configuration

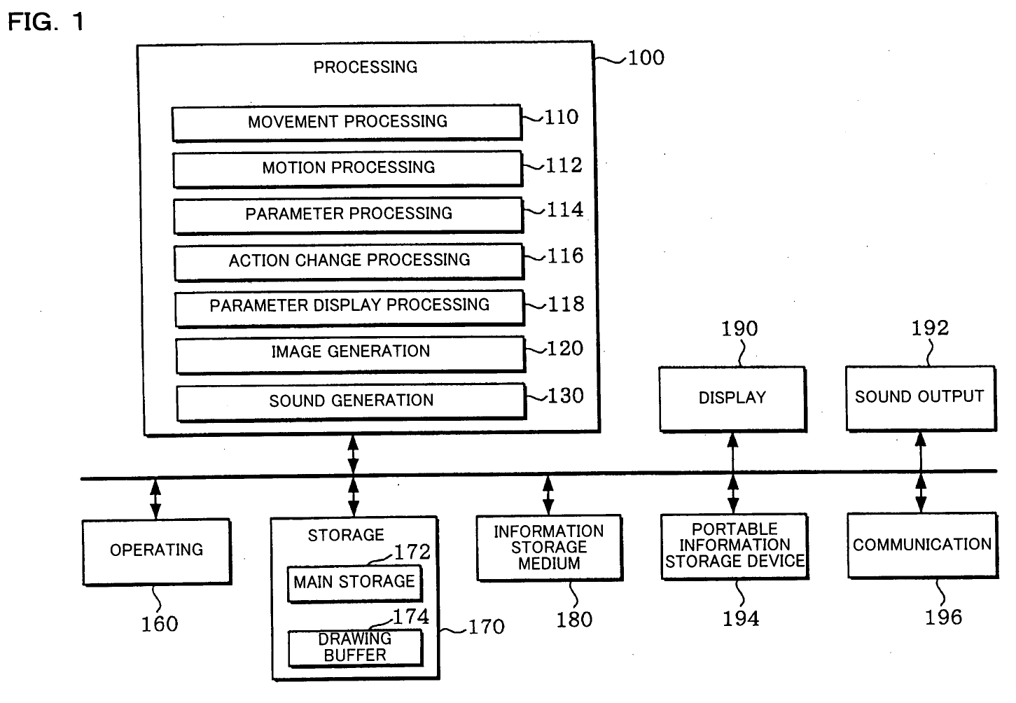

FIG. 1 shows an example of a functional block diagram of an image generation system (game system) of the present embodiment. The image generation system of the present embodiment does not necessarily include all the sections (functional blocks) shown in FIG. 1. The image generation system may have a configuration in which a part of the sections (operating section 160, portable information storage device 194, or communication section 196, for example) is omitted.

An operating section 160 allows a player to input operation data. The function of the operating section 160 may be realized by hardware such as a lever, button, steering wheel, shift lever, accelerator pedal, brake pedal, microphone, sensor, touch panel, or casing.

A storage section 170 provides a work area for a processing section 100, a communication section 196, and the like. The function of the storage section 170 may be realized by hardware such as a RAM.

An information storage medium 180 (computer-readable medium) stores a program, data, and the like. The function of the information storage medium 180 may be realized by hardware such as an optical disk (CD, DVD), magneto-optical disk (MO), magnetic disk, hard disk, magnetic tape, or memory (ROM). The processing section 100 performs various types of processing of the present embodiment based on a program (data) stored in the information storage medium 180. Specifically, a program for causing a computer to function as each section of the present embodiment (program for causing a computer to realize each section) is stored (recorded) in the information storage medium 180.

A display section 190 outputs an image generated by the present embodiment. The function of the display section 190 may be realized by hardware such as a CRT, LCD, touch panel, or head mount display (HMD).

A sound output section 192 outputs sound generated by the present embodiment. The function of the sound output section 192 may be realized by hardware such as a speaker or a headphone.

A portable information storage device 194 stores personal data of a player, saved data of a game, and the like. As the portable information storage device 194, a memory card or a portable game device may be employed.

The communication section 196 performs various types of control for communicating with the outside (host device or other image generation system, for example). The function of the communication section 196 may be realized by hardware such as various processors or communication ASIC, or by a program.

The program (data) for causing a computer to function as each section of the present embodiment may be distributed to the information storage medium 180 (storage section 170) from an information storage medium included in a host device (server) through a network and the communication section 196. Use of the information storage medium of the host device (server) is included within the scope of the present invention.

The processing section 100 (processor) performs various types of processing such as game processing, image generation processing, or sound generation processing based on operation data from the operating section 160 or a program. In this case, the processing section 100 performs various types of processing by using a main storage section 172 in the storage section 170 as a work area. The function of the processing section 100 may be realized by hardware such as various processors (CPU, DSP, etc.) or ASIC (gate array, etc.), or by a program (game program).

The processing section 100 includes a movement processing section 110, a motion processing section 112, a parameter processing section 114, an action change processing section 116, a parameter display processing section 118, an image generation section 120, and a sound generation section 130. The processing section 100 does not necessarily include all of these sections (functional blocks). A part of these sections may be omitted.

The movement processing section 110 performs processing of calculating movement information (position information, direction information, speed information, or acceleration information) of a moving object (object). Specifically, the movement processing section 110 performs processing of moving the moving object in an object space based on the operation data input by the player by using the operating section 160 and the game program.

In more detail, the movement processing section 110 changes the position or the rotation angle (direction) of the moving object every frame (1/60 second, 1/30 second, etc.), for example. The position (X, Y, or Z coordinates) and the rotation angle (rotation angle around the X, Y, or Z axis) of the moving object in the (k−1)th frame are referred to as Pk−1 and θk−1, and the amount of change in position (speed) and the amount of change in rotation (rotational speed) of the object in one frame are referred to as ΔP and Δθ. The position Pk and the rotation angle θk of the moving object in the k-th frame are calculated according to the following equations (1) and (2), for example.

Pk=Pk−1+ΔP (1)

θk=θk−1+Δθ (2)

The motion processing section 112 performs processing of calculating motion information of the moving object (position information and direction information of each part of the moving object). Specifically, the motion processing section 112 performs processing of allowing the moving object to make a motion (or animation) based on the operation data input by the player by using the operating section 160 or the game program.

In more detail, the motion processing section 112 performs processing of reproducing the motion of the moving object based on motion data. Specifically, the motion processing section 112 reads the motion data including the position or the rotation angle (direction) of each part object (bone which makes up a skeleton) which makes up the moving object (model object, skeleton, or character) from the storage section 170 (motion data storage section). The motion processing section 112 reproduces the motion of the moving object by moving each part object (bone) of the moving object (by transforming the skeleton shape).

The parameter processing section 114 performs processing of changing (increasing or decreasing) values of parameters (status parameters) of the moving objects (first and second moving objects).

In more detail, the parameter processing section 114 changes a value of a first parameter of the second moving object when it is determined that the first moving object (viewpoint) and the second moving object have been in an approach relation (given position relation). In other words, the parameter processing section 114 changes the value of the first parameter based on at least one of position information (position coordinates) of the first and second moving objects, speed information of the first moving object (relative difference in speed between the first and second moving objects), and acceleration information of the first moving object (relative difference in acceleration between the first and second moving objects). In other words, the parameter processing section 114 changes a value of a pressure parameter of the second moving object when it is determined that the first moving object and the second moving object have a relation in which the first moving object applies pressure (virtual pressure) to the second moving object.

The first and second moving objects are objects which move in the object space (game space) by the operations of the players (human player or computer player).

The condition wherein the first moving object and the second moving object are in an approach relation means that the first moving object approaches the second moving object. The approach relation (relation determined by position or direction) may be determined based on the position information of the first and second moving objects (distance between the first and second moving objects), for example. The approach relation (position relation) may be determined based on the position information of the first and second moving objects and at least one of the speed information and the acceleration information of the first moving object. The approach relation (position relation) may be determined based on the position information of the first and second moving objects, at least one of the speed information and the acceleration information of the first moving object, and at least one of the speed information and the acceleration information of the second moving object. The approach relation (position relation) may be determined by further taking the direction relation between the first and second moving objects into consideration.

In more detail, the parameter processing section 114 may determine whether or not the first and second moving objects are in an approach relation based on the time difference between the first and second moving objects. For example, the parameter processing section 114 determines that the first and second moving objects are in an approach relation when the time difference TD between the first moving object and the second moving object which runs ahead in a competitive game becomes smaller than a given set time difference TS (which may be variable), and performs the processing of changing the parameter of the second moving object.

The time difference is the difference in passing time between the first and second moving objects at each point (first to J-th points) on the course in a strict sense. In the case where the passing time of the second moving object is TI2 (30 seconds, for example) and the passing time of the first moving object which runs behind the second moving object is TI1 (31 seconds, for example) at the I-th point (1≦I≦J) on the course, the time difference TD at the I-th point is TI1-TI2 (one second, for example). However, the time difference is not limited to the time difference in a strict sense, and may be a pseudo time difference. The time difference TD between the first and second moving objects may be determined to be smaller than the set time difference TS when the first moving object is positioned within a distance range which increases as the speed of the second moving object increases, for example. The value of the first parameter may be changed when the first moving object is positioned within such a distance range and the ratio of the speed of the first moving object to the speed of the second moving object is equal to or greater than a set ratio (1.0 or more, or 0.8 to 0.9 or more, for example). This enables the approach relation between the first and second moving objects to be determined by utilizing the pseudo time difference without calculating the difference in passing time at each point on the course.

The parameter processing section 114 performs processing of resetting (decreasing) the value of the first parameter when the first moving object is positioned outside first and second distance ranges (distance ranges which increase as the speed of the second moving object increases) in front of and behind the second moving object. When the first moving object is positioned in the first distance range (distance range smaller than the second distance range), the parameter processing section 114 does not perform the processing of resetting (decreasing) the value of the first parameter and leaves the first parameter unchanged from the previous value.

The parameter processing section 114 may perform the following processing when the first moving object is positioned in a third distance range behind the second moving object (distance range which is smaller than the second distance range and increases as the speed of the second moving object increases). Specifically, the parameter processing section 114 changes the value of the first parameter at a higher change rate as the distance (relative distance) between the first and second moving objects increases in a direction (X direction or Y direction in the course coordinate system) which intersects the traveling direction (direction along the course; Z direction in the course coordinate system).

The first parameter is a parameter which influences the change in action of the moving object (second moving object) (parameter for determining whether or not to generate an action change event). In more detail, the first parameter is a parameter which virtually indicates the psychological factor of the moving object (human player or computer player who operates the moving object). In more detail, the first parameter is a pressure parameter which virtually indicates the degree of pressure applied to the moving object (human player or computer player who operates the moving object).

The action change processing section 116 performs processing of changing the action of the moving object. In more detail, the action change processing section 116 generates an action change event (event for changing the action of the moving object) in which the action (movement or motion) of the moving object changes when it is determined that the value of the first parameter of the moving object (second moving object) has reached a threshold value (exceeded the threshold value).

If the action change event is generated, action control (movement control or motion control by the movement processing section 110 or the motion processing section 112) differing from the action control before the action change event is generated is performed for the moving object. For example, usual action control is performed for the moving object before the action change event is generated, and special action control (action change control) is performed for the moving object after the action change event has been generated. The moving object moves or makes a motion by this special action control.

In the case where the action change event is generated, a parameter (parameter other than the first parameter; action control parameter; ability parameter) of the moving object (second moving object) may be changed. For example, in the case where the action change event is generated, a speed control parameter, acceleration control parameter, speed reduction control parameter, direction control parameter, stability parameter, striking ability parameter, or defense ability parameter of the moving object may be changed. In more detail, in the case where the action change event is generated, the maximum speed (speed control parameter) of the moving object may be reduced, engine power (acceleration control parameter) may be reduced, braking performance (speed reduction control parameter) may be reduced, or steering performance (direction control parameter) may be reduced. Or, in the case where the action change event is generated, weapon performance (striking ability parameter) of the moving object may be reduced or shield performance and radar performance (defense ability parameter) of the moving object may be reduced.

The parameter display processing section 118 performs processing of displaying the parameter of the moving object.

In more detail, the parameter display processing section 118 performs processing of displaying a parameter display object (parameter gauge) which visually indicates the change in the value of the first parameter of the moving object (second moving object). The parameter display object may be three-dimensionally disposed in the object space, or disposed (displayed) on a two-dimensional screen as a sprite. The shape of the parameter display object may be rectangular, circular, or various other shapes.

The parameter display object may be displayed while being associated with each of a plurality of moving objects (second moving objects). In this case, the parameter display object may be disposed near the position of each moving object. For example, the parameter display object for a moving object A is disposed near the position of the moving object A, and the parameter display object for a moving object B is disposed near the position of the moving object B.

The parameter display processing section 118 changes the display form of the parameter display object which is displayed while being associated with each of the second moving objects according to the threshold value of the first parameter set for each of the second moving objects. In more detail, the parameter display processing section 118 increases the length of the parameter display object as the threshold value of the first parameter increases.

The image generation section 120 performs drawing processing based on the results for various types of processing performed by the processing section 100. The image generation section 120 generates an image and outputs the image to the display section 190. Specifically, in the case of generating a three-dimensional game image, geometry processing such as coordinate transformation, clipping processing, perspective transformation, or light source processing is performed. Drawing data (position coordinates of the apices of a primitive surface, texture coordinates, color data, normal vector, a value, and the like) is created based on the processing result. The object (one or more primitive surfaces) after perspective transformation (after geometry processing) is drawn in a drawing buffer 174 (buffer which can store image information in pixel units such as a frame buffer or a work buffer) based on the drawing data (primitive surface data). This allows an image viewed from a virtual camera (given viewpoint) to be generated in the object space.

The sound generation section 130 performs sound processing based on the results for various types of processing performed by the processing section 100. The sound generation section 130 generates game sound such as BGM, effect sound, or voice, and outputs the sound to the sound output section 192.

The image generation system of the present embodiment may be a system exclusive for a single player mode in which only one player can play the game, or a system provided with a multi-player mode in which a plurality of players can play the game in addition to the single player mode.

In the case where a plurality of players play the game, game images and game sound provided to these players may be generated by using one terminal, or generated by using a plurality of terminals (game machines or portable telephones) connected through a network (transmission line or communication line) or the like.

2. Method of Present Embodiment

A method of the present embodiment is described below with reference to the drawings.

2.1 Pressure Parameter

In the present embodiment, the pressure parameter (first parameter in a broad sense; hereinafter the same) which virtually indicates the degree of pressure is newly introduced.

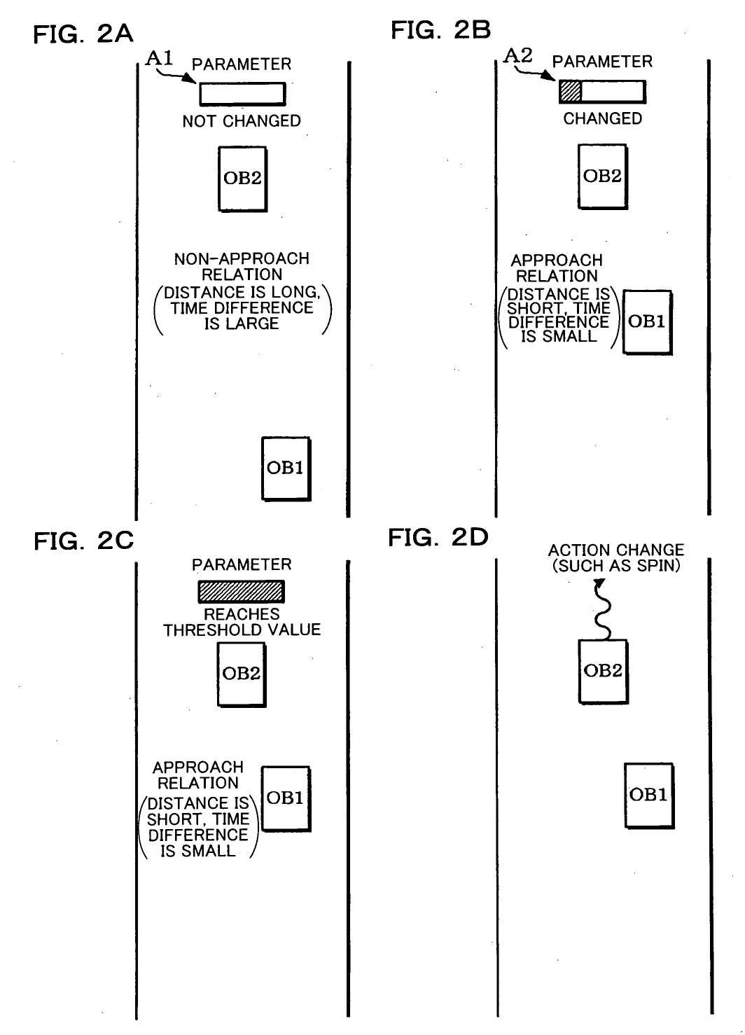

In FIG. 2A, a moving object OB1 (first moving object, viewpoint) and a moving object OB2 (second moving object) are moving in the object space (on the course), for example. The moving objects OB1 and OB2 are not in an approach relation in FIG. 2A. For example, the distance (straight-line distance, distance along the course, or the like) between the moving objects OB1 and OB2 is long. In more detail, the time difference (time difference obtained by dividing the distance by the speed) between the moving objects OB1 and OB2 is large. In this case, the value of the pressure parameter is not changed as indicated by A1 shown in FIG. 2A.

In FIG. 2B, the moving objects OB1 and OB2 are in an approach relation. For example, the distance between the moving objects OB1 and OB2 is short. In more detail, the time difference between the moving objects OB1 and OB2 is small. In this case, the value of the pressure parameter (psychological parameter) changes (increases) as indicated by A2 shown in FIG. 2B. This enables the situation in which pressure is applied to the player of the moving object OB2 to be expressed.

In FIG. 2C, the value of the pressure parameter reaches the threshold value (maximum value) as indicated by A3 by allowing the approach relation between the moving objects OB1 and OB2 to be maintained. As a result, the action change event of the moving object OB2 to which the pressure is applied is generated, as shown in FIG. 2D. In more detail, the moving object OB2 reacts to the pressure applied to the moving object OB2. In other words, the moving object OB2 takes erroneous action (movement or motion) (fails in the operation). In more detail, the moving object OB2 accelerates too early and spins. Or, the moving object OB2 excessively delays the brake operation and runs off the line to a large extent. Or, the moving object OB2 enters a comer at excessively high speed and runs off the course (crashes against the wall). Or, the moving object OB2 cannot pass the comer and takes a short cut in the comer. Or, the moving object OB2 performs an excessive brake operation and the wheels of the moving object OB2 become locked.

The action change of the moving object OB2 may be realized by allowing the player (computer player or human player) who operates the moving object OB2 to fail in the operation, for example. In the case where the player who operates the moving object OB2 is a computer player, failure in the operation may be generated by changing the operation by an algorithm (accelerator operation, brake operation, steering operation, or the like). In the case where the player who operates the moving object OB2 is a human player, failure in the operation may be generated by changing the operation of the player even in the case where the player performs a correct operation.

According to the above method of the present embodiment, the psychological warfare factor in motor sport in which pressure is applied to the player of the moving object which runs ahead can be introduced into the game. For example, a situation in which the player (computer player) of the moving object which runs ahead is psychologically run down and fails in the operation can be created by running close to the moving object (computer car) which runs ahead. This enables the range of interest in the game for the player to be widened, whereby an emotional race can be produced.

The change in action may not be generated under a special situation even if the value of the pressure parameter reaches the threshold value (maximum value).

2.2 Display of Pressure Parameter

In the present embodiment, the parameter display object (pressure meter, pressure gauge, or pressure bar in a narrow sense) which indicates the change in the value of the pressure parameter (first parameter) of the moving object is displayed.

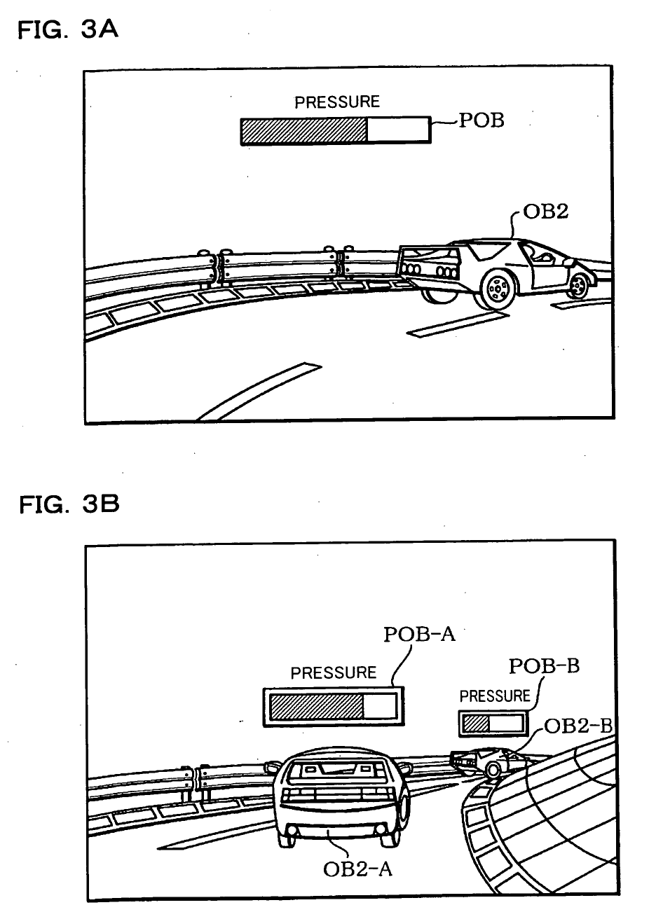

In FIG. 3A, a parameter display object POB (pressure meter) which indicates the change in the value of the pressure parameter of the moving object OB2 (second moving object) which runs in front of the player's moving object (first moving object, player's viewpoint) is displayed (disposed). In this case, the parameter display object POB may be expressed by using a two-dimensional sprite used to display a score or a speedometer on a two-dimensional screen, for example. The parameter display object POB expressed by the two-dimensional sprite is displayed at a fixed position on the screen without being allowed to follow the moving object OB2, even if the moving object OB2 moves.

In FIG. 3B, parameter display objects POB-A and POB-B which indicate the change in the value of the pressure parameter (first parameter) of each of moving objects OB2-A and OB2-B are displayed (disposed) while being associated with the moving objects OB2-A and OB2-B. Specifically, the parameter display object POB-A indicates the change in the value of the pressure parameter of the moving object OB2-A, and the parameter display object POB-B indicates the change in the value of the pressure parameter of the moving object OB2-B. The parameter display objects POB-A and POB-B move so as to follow the moving objects OB2-A and OB2-B, respectively. The parameter display objects POB-A and POB-B become larger as the parameter display objects POB-A and POB-B are closer to the viewpoint and become smaller as the parameter display objects POB-A and POB-B move away from the viewpoint (perspective projection transformed) in the same manner as the moving objects OB2-A and OB2-B. In this case, the parameter display objects POB-A and POB-B may be expressed by objects formed of a polygon (primitive in a broad sense) in the same manner as the moving objects OB2-A and OB2-B, or expressed by three-dimensional sprites of which the sizes change according to the distance from the viewpoint. In FIG. 3B, the two parameter display objects POB-A and POB-B are displayed while being associated with the two moving objects OB2-A and OB2-B. However, three or more parameter display objects may be displayed while being associated with three or more moving objects.

The player can visually recognize the state in which another player (computer player or other human player) who operates the moving object which runs ahead is being psychologically run down due to the pressure by displaying the parameter display object. Specifically, the player can recognize the state in which another player is being run down by watching an increase in the pressure parameter value of the parameter display object. Therefore, a psychological warfare factor can be introduced into the game, whereby the degree of devotion of the player to the game can be increased.

The player may be allowed to easily recognize that the pressure parameter value has reached the threshold value by turning on and off the entire parameter display object (bar) when the pressure parameter value (first parameter value in a broad sense) of the parameter display object reaches the threshold value (maximum value), for example. This enables the player to predict that the moving object running ahead fails in the operation, whereby the player easily avoids or passes the moving object running ahead.

The color or shape of the parameter display object may be changed according to the pressure parameter value.

The shape of the parameter display object is not limited to the quadrilateral shape shown in FIGS. 3A and 3B, and may be circular (circle graph) or the like.

The name of the moving object or the name of the player who operates the moving object may be displayed accompanying the parameter display object.

In the case where a plurality of moving objects are running, only the parameter display object of a closer moving object (closest moving object) may be displayed instead of displaying the parameter display objects of all the moving objects. In other words, the parameter display object may be displayed only in the case where another moving object approaches instead of always displaying the parameter display object. In this case, the parameter display object may be displayed at a fixed position on the screen irrespective of the position of the moving object as shown in FIG. 3A, or displayed so as to follow the movement of the moving object as shown in FIG. 3B. In the display method of the parameter display object shown in FIGS. 3A and 3B, an event differing from the action change event may be generated when the pressure parameter (first parameter) reaches the threshold value.

The state of the change in the value of the pressure parameter (first parameter) may be expressed by using sound or the like instead of the parameter display object. Specifically, the game sound (sound output from the image generation system, such as BGM, effect sound, or voice) changes according to the change in the value of the pressure parameter (first parameter) (when the first and second moving objects are in an approach relation).

For example, the voice of the moving object OB2 or a character (pseudo player) which is boarding the moving object OB2 changes according to the change in the value of the pressure parameter (first parameter) (when the moving objects OB1 and OB2 are in an approach relation). Specifically, the voice of the moving object OB2 or the character (pseudo player) which is boarding the moving object OB2 changes into a hasty voice or provocative voice, or the volume or tone of the voice changes. In more detail, a statement (voice pattern) such as “Damn it!” or “You'll never pass me!” is generated, or the volume of the voice is increased, or the tone of the voice is raised.

The effect sound (engine sound, exhaust sound, movement sound, motion sound, wind sound, or the like) generated by the moving object OB2 may be changed according to the change in the value of the pressure parameter (first parameter) (when the moving objects OB1 and OB2 are in an approach relation). Specifically, the volume of the effect sound is increased or the tone of the effect sound is raised as the moving object OBI approaches the moving object OB2.

Background music (BGM) being played during the game may be changed according to the change in the value of the pressure parameter (first parameter) (when the moving objects OB1 and OB2 are in an approach relation). Specifically, the BGM changes to another BGM (other music), or the volume, tone, or tempo of the BGM changes. In more detail, the BGM changes from the usual BGM to tense BGM or BGM in up-tempo, the volume of the BGM is increased, the tone of the BGM is raised, or the tempo of the BGM is made faster.

This enables the psychological state of the player run down due to the pressure to be expressed more realistically.

2.3 Setting of Threshold Value and Change Rate for Each Moving Object

In the present embodiment, at least one of the threshold value (maximum value) and the change rate (reference increase value or reference decrease value) of the pressure parameter (first parameter) can be set for each moving object. Specifically, setting of the threshold value or the change rate of the pressure parameter may be allowed to differ for each moving object.

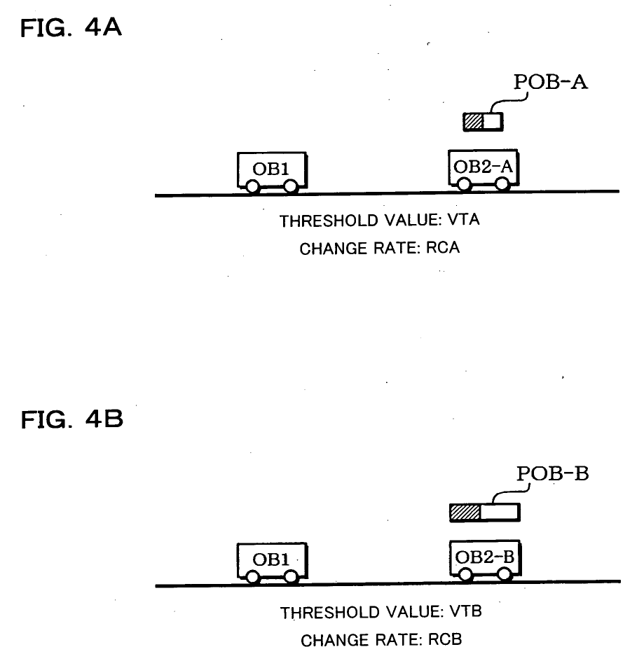

In FIG. 4A, the moving objects OB1 and OB2-A are in an approach relation. In this case, the threshold value of the pressure parameter is set to a threshold value VTA for the moving object OB2-A, and the change rate is set to a change rate RCA for the moving object OB2-A, for example. In FIG. 4B, the moving objects OB1 and OB2-B are in an approach relation. In this case, the threshold value of the pressure parameter is set to a threshold value VTB for the moving object OB2-B, and the change rate is set to a change rate RCB for the moving object OB2-B. Therefore, the threshold value of the pressure parameter may be increased (or decreased) for the moving object OB2-A, and the threshold value may be decreased (or increased) for the moving object OB2-B. The change rate of the pressure parameter may be increased (or decreased) for the moving object OB2-A, and the change rate may be decreased (or increased) for the moving object OB2-B.

Therefore, a moving object which easily fails in the operation due to the pressure can be provided by decreasing the threshold value or increasing the change rate, for example. A moving object which does not easily fail in the operation even if the pressure is applied to the moving object can be provided by increasing the threshold value or decreasing the change rate. This enables a mentally weak driver and a mentally strong driver to be expressed, whereby the psychological warfare of the competitive game can be provided with variety.

The threshold value or the change rate of the pressure parameter (first parameter) of the moving object may be set according to the relative relation between the moving objects (difference in ability, difference in type, difference in size, or the like).

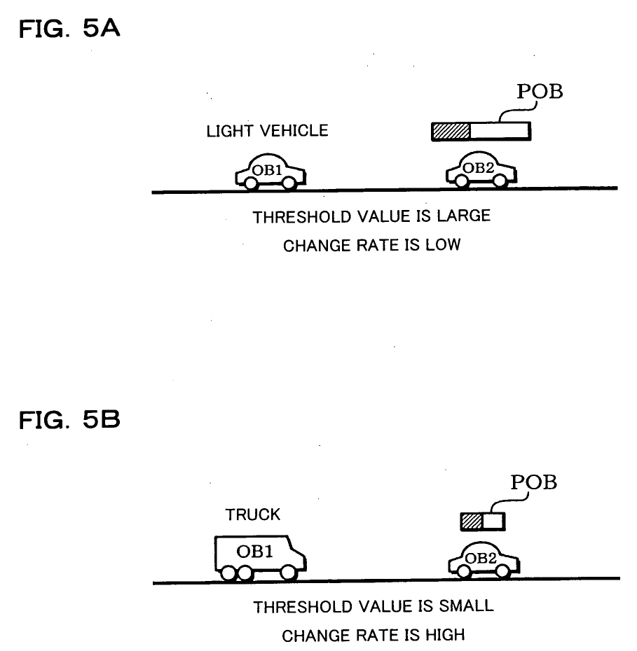

In FIG. 5A, the moving object OB1 which runs after the moving object OB2 is a light vehicle. In FIG. 5B, the moving object OB1 is a truck. In this case, the threshold value of the pressure parameter of the moving object OB2 is increased and the change rate is decreased in FIG. 5A, and the threshold value of the moving object OB2 is decreased and the change rate is increased in FIG. 5B, even though the moving object OB2 is run after by the moving object OB1 in the both cases. This enables creation of a situation in which a greater amount of pressure is applied to the moving object when the moving object is run after by a truck rather than a light vehicle, whereby the variety of the psychological warfare can be increased.

Various variations can be possible as the setting of the threshold value and the change rate based on the relative relation between the moving objects. For example, the threshold value may be decreased and the change rate may be increased in the case where the moving object is followed by a high-performance sport car or a police car, whereby a situation in which a great amount of pressure is applied to the moving object can be expressed.

The setting of the threshold value and the change rate shown in FIGS. 4A to 5B may be realized by using a table of the threshold value or a table of the change rate provided for each moving object or for each relation between the moving objects, for example.

In the case where the threshold value of the pressure parameter (first parameter) is allowed to differ for each moving object, it is preferable to allow the shape or color of the parameter display object to differ according to the difference in the threshold value.

In more detail, as shown in FIGS. 4A to 5B, the length of the parameter display object POB (bar) is increased for the moving object of which the threshold value is large, and the length of the parameter display object POB is decreased for the moving object of which the threshold value is small. This enables the player who runs after the moving object to easily recognize whether the moving object (driver) the player is running after is weak or strong against pressure, whereby the interest of the psychological warfare can be further increased. The color or shape of the parameter display object may be changed according to the difference in the change rate of the pressure parameter (first parameter).

2.4 Reset of Pressure Parameter

The value of the pressure parameter (first parameter) of the present embodiment is reset (decreased) on a given condition. In more detail, the value of the pressure parameter (first parameter) is reset (decreased) when the moving objects are not in an approach relation (given position relation).

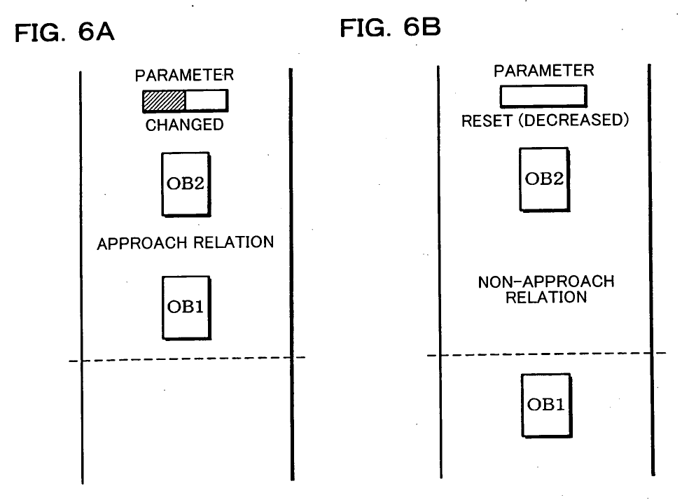

In FIG. 6A, since the moving objects OB1 and OB2 are in an approach relation (given position relation), the value of the pressure parameter changes (increases), for example. In FIG. 6B, since the moving objects OB1 and OB2 are in a non-approach relation (do not have the given position relation), the value of the pressure parameter which has been changed (increased) when the moving objects OB1 and OB2 are in an approach relation (as shown in FIG. 6A) is reset (decreased). In more detail, the value of the pressure parameter becomes zero. This allows the pressure applied by being run after by the moving object OB1 to be removed since the moving object OB1 goes away, whereby the psychological state in which the player is liberated from the pressure can be expressed.

The moving object OB1, which runs after the moving object OB2, cannot induce the moving object OB2 to fail in the operation (action change in a broad sense) unless the moving object OB1 maintains the approach relation with the moving object OB2.

Therefore, the degree of difficulty in applying pressure is increased, whereby the interest of the game is increased.

If the moving object OB1 approaches the moving object OB2 after the value of the pressure parameter has been reset, the pressure parameter changes (increases).

In the case where the moving objects OB1 and OB2 are in a non-approach relation, the value of the pressure parameter may be decreased at a high change rate without immediately resetting the value of the pressure parameter.

In the case where a plurality of moving objects OB2 exist, the value of the pressure parameter may be reset (decreased) by determining whether or not the moving object OB1 has a non-approach relation with each moving object.

2.5 Consideration of Speed Information and Acceleration Information

In the present embodiment, the approach relation between the moving objects (whether or not the moving objects have the given position relation) may be determined while taking the speed information or the acceleration information of the moving object into consideration, in addition to the position information of the moving object.

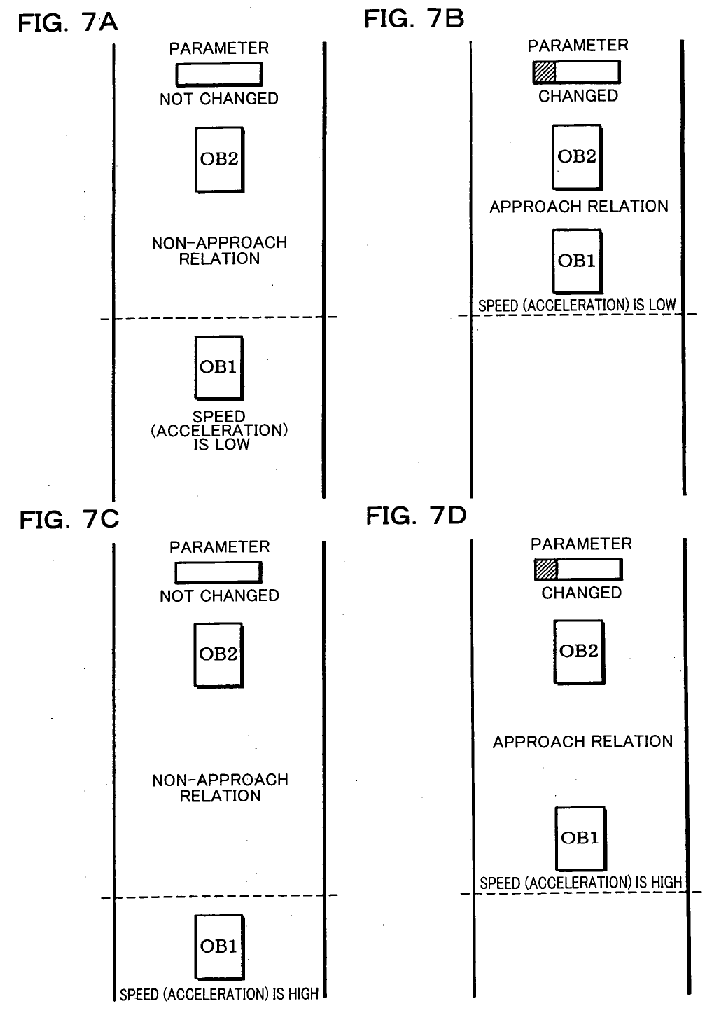

For example, the speed (or acceleration) of the moving object OB1 which runs after the moving object OB2 is low in FIGS. 7A and 7B, and the speed (or acceleration) of the moving object OB1 is high in FIGS. 7C and 7D. In this case, the moving objects OB1 and OB2 are determined to be in an approach relation in FIGS. 7C and 7D even though the distance between the moving objects OB1 and OB2 is longer than that in FIGS. 7A and 7B, and the value of the pressure parameter changes. Specifically, the distance at which the moving objects OB1 and OB2 are determined to be in an approach relation and the pressure parameter value starts to be changed is increased as the speed (or acceleration) of the moving object OB1 is higher. Therefore, the timing at which the pressure is applied to the moving object OB2 is brought forward as the speed (or acceleration) of the moving object OB1 which follows the moving object OB2 is increased, whereby real psychological warfare can be realized.

The approach relation (position relation) between the moving objects OB1 and OB2 may be determined taking into consideration the speed information and the acceleration information of the moving object OB2 (second moving object), in addition to the speed information and the acceleration information of the moving object OB1 (first moving object). Specifically, the value of the pressure parameter may be changed by determining whether or not the moving objects OB1 and OB2 are in an approach relation according to the relative difference in speed or acceleration between the moving objects OB1 and OB2. The approach relation between the moving objects OB1 and OB2 may be determined based on the speed information or the acceleration information without taking the position information into consideration.

The threshold value or the change rate of the pressure parameter (first parameter) may be changed based on the speed information or the acceleration information of the moving object. For example, the threshold value of the pressure parameter is decreased and the change rate of the pressure parameter is increased as the speed or acceleration of the moving object is higher. This enables more real and diversified psychological warfare to be realized.

The threshold value and the change rate of the pressure parameter (first parameter) may be changed based on the position relation between the moving objects (position information, distance between the moving objects, or approach relation). For example, the change rate of the pressure parameter is increased as the distance between the moving objects is shorter. This enables a situation to be created in which the pressure is increased as the moving objects approach.

The method of the present embodiment described above may be applied to various games in addition to a competitive game such as the car game.

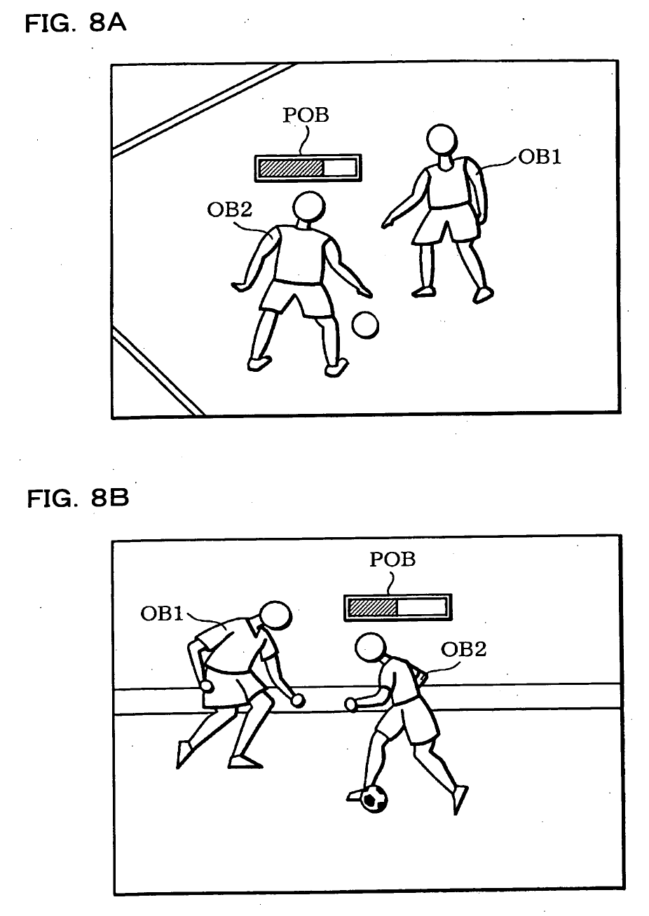

FIG. 8A shows an example in which the method of the present embodiment is applied to a basket-ball game. In the competitive game described with reference to FIGS. 2A to 2D, pressure is applied to the moving object OB2 which runs ahead in the case where the moving object OB1 which runs behind approaches the moving object OB2.

In the basket-ball game shown in FIG. 8A, pressure is also applied to the moving object OB2 in the case where the moving object (character) OB1 is positioned in front of the moving object OB2. If the value of the pressure parameter (POB) reaches the threshold value, the action change event of the moving object OB2 is generated, whereby the moving object OB2 easily fails. In more detail, the moving object OB2 loses the ball. Or, the moving object OB2 easily fails in passing or shooting. Or, the moving object OB2 is easily deprived of the ball by other moving object. Or, the moving object OB2 falls down. The action change of the moving object OB2 may be realized by controlling the motion of the moving object OB2 and the like.

FIG. 8B shows an example in which the method of the present embodiment is applied to a soccer game. In FIG. 8B, if the moving objects OB1 and OB2 are in an approach relation, the action change event of the moving object OB2 is generated, whereby the moving object OB2 easily fails. In more detail, the moving object OB2 loses the ball, fails in dribbling, passing, or shooting, is easily deprived of the ball, or falls down.

The method of the present embodiment may be applied to various games such as a sport game other than the basket-ball game and the soccer game, fighting game, or shooting game.

2.6 Determination of Approach Relation Based on Time Difference

As described above, whether or not the moving objects OB1 and OB2 are in an approach relation may be determined based on either the distance between the moving objects OB1 and OB2 or the time difference between the moving objects OB1 and OB2. However, if the approach relation between the moving objects OB1 and OB2 is determined merely based on the distance in a competitive game such as a car game in which the moving objects OB1 and OB2 compete, the following problem occurs.

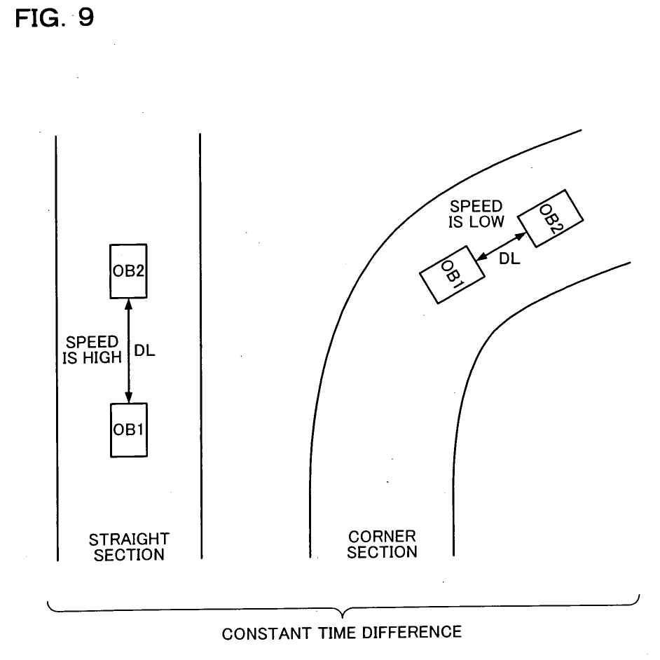

In the case where the operational skills of the drivers (human or computer) who operate the moving objects OB1 and OB2 are the same, the time difference (lap difference) between the moving objects OB1 and OB2 is approximately constant. As shown in FIG. 9, in the case where the time difference is constant, the distance DL between the moving objects OB1 and OB2 should increase in the straight section of the course since the speed is high, and the distance DL should decrease at the comer of the course since the speed is low.

However, if the approach relation between the moving objects OB1 and OB2 is determined merely based on the distance DL, there may be a case where it is determined that the moving objects OB1 and OB2 are not in an approach relation in the straight section of the course although the time difference is small, and that the moving objects OB1 and OB2 are in an approach relation at the corner of the course although the time difference is large. In the worst case, the value of the pressure parameter is reset (see FIGS. 6A and 6B) in the straight section of the course, although the moving objects OB1 and OB2 remain in an approach relation since the time difference between the moving objects OB1 and OB2 is small, whereby a result which cannot satisfy the player occurs.

Therefore, it is preferable to determine the approach relation between the moving objects OB1 and OB2 based on the time difference. Specifically, the moving objects OB1 and OB2 are determined to be in an approach relation when the time difference TD becomes smaller than the set time difference TS, and the value of the pressure parameter of the moving object OB2 is changed. In more detail, the value of the pressure parameter is changed (increased) at a higher change rate (increase rate) as the time difference between the moving objects OB1 and OB2 decreases.

However, it is difficult to calculate the time difference in a strict sense (difference in passing time at each point of the course) in game processing. Specifically, calculation of the passing time at each point of the course considerably increases the amount of calculation result data, whereby the capacity of the storage section which stores the calculation result data becomes insufficient. Moreover, if the number of measurement points on the course is increased in order to obtain an accurate passing time, the processing load of calculation is excessively increased.

Therefore, it is preferable to determine the approach relation by using the pseudo time difference instead of the time difference in a strict sense. In more detail, the time difference between the moving objects OB1 and OB2 is determined to be smaller than the set time difference when the moving object OB1 is positioned within a distance range which increases as the speed of the moving object OB2 increases (distance range which follows the movement of the moving object OB2). In other words, the distance range which increases as the speed of the moving object OB2 increases is set as a range in which pressure is applied to the moving object OB2.

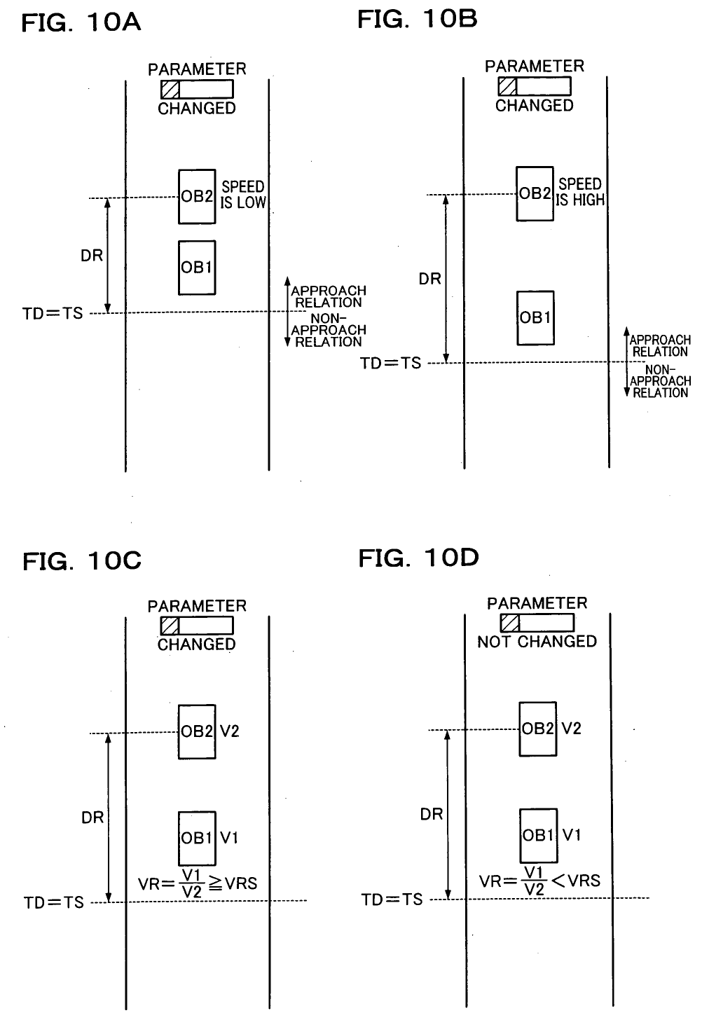

In FIGS. 10A and 10B, the distance range DR is a distance range which decreases when the speed of the moving object OB2 is low, and increases when the speed of the moving object OB2 is high. The moving objects OB1 and OB2 are determined to be in an approach relation when the moving object OB1 is positioned within the distance range DR, whereby pressure is applied to the moving object OB2. The moving objects OB1 and OB2 are determined to be in a non-approach relation when the moving object OB1 is positioned outside the distance range DR, whereby pressure is not applied to the moving object OB2.

This allows the distance range DR, in which pressure is applied to the moving object OB2, to increase in the straight section of the course shown in FIG. 9, and to decrease at the comer. Therefore, even if the distance DL increases in the straight section of the course due to an increase in the speed of the moving objects OB1 and OB2, the moving objects OB1 and OB2 are determined to be in an approach relation. Therefore, determination of the approach relation based on the pseudo time difference can be expressed with a reduced processing load.

The time difference in a strict sense reflects not only the speed of the moving object OB2, but also the speed of the moving object OB1. Therefore, the value of the pressure parameter of the moving object OB2 is changed (increased) when the moving object OB1 is positioned within the distance range DR which increases as the speed of the moving object OB2 increases and the speed ratio (percentage) of the moving object OB1 to the moving object OB2 is equal to or greater than a set ratio. In FIG. 10C, since the ratio VR of the speed V1 of the moving object OB1 to the speed V2 of the moving object OB2 (V1/V2) is equal to or greater than the set ratio VRS, the value of the pressure parameter changes (increases). In FIG. 10D, since the speed ratio VR is smaller than the set ratio VRS, the value of the pressure parameter does not change.

This enables the approach relation between the moving objects OB1 and OB2 to be determined while reflecting not only the speed of the moving object OB2, but also the speed of the moving object OB1. Therefore, the approach relation can be determined based on the determination standard close to that when using the time difference in a strict sense while using the pseudo time difference based on the distance range DR.

The set ratio VRS in FIGS. 10C and 10D may be set at 1.0, for example. This allows the value of the pressure parameter of the moving object OB2 to change when the moving object OB1 positioned within the distance range DR moves relatively closer to the moving object OB2, whereby the approach relation can be determined based on the determination standard close to that when using the time difference in a strict sense.

However, even if the skills of the drivers are the same and the time difference is constant, the speed ratio VR of the moving object OB1 to the moving object OB2 changes to a small extent due to variation of the operation of the driver or variation of the operation environment. Therefore, if the set ratio VRS is set at 1.0, the value of the pressure parameter does not change even if the moving object OB1 moves relatively away from the moving object OB2 due to variation of the operation or the like, whereby the player gets an unnatural impression. Therefore, it is preferable to set the set ratio VRS at about 0.8 to 0.9. This allows the value of the pressure parameter to continue to change even if the moving object OB1 moves away from the moving object OB2 due to variation of the operation or the like, whereby a situation in which the player gets an unnatural impression can be prevented.

2.7 Intermediate Set Time Difference

If the value of the pressure parameter reaches the threshold value merely because the approach relation is continuously maintained for a long period of time although the moving object OB2 is not very close to the moving object OB1, the player gets an unnatural impression, whereby a real pressure expression cannot be realized.

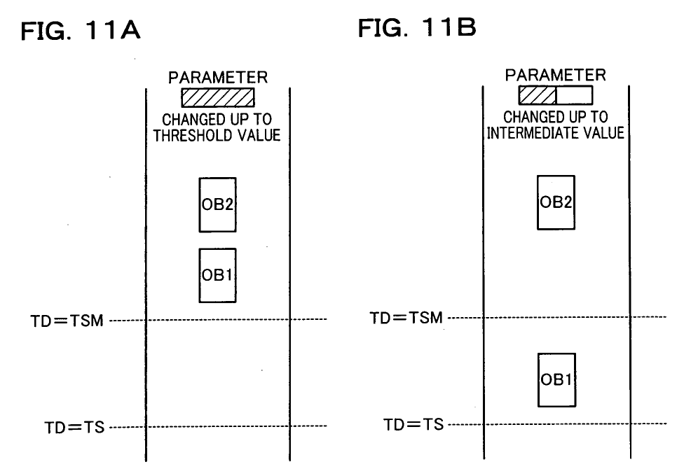

Therefore, it is preferable to change the value of the pressure parameter by using a method shown in FIGS. 11A and 11B. Specifically, as shown in FIG. 11A, the value of the pressure parameter is changed up to the threshold value when the time difference TD between the moving objects OB1 and OB2 is smaller than an intermediate set time difference TSM. On the other hand, as shown in FIG. 11B, the value of the pressure parameter is changed up to the intermediate value which is smaller than the threshold value when the time difference TD between the moving objects OB1 and OB2 is greater than the intermediate set time difference TSM and is smaller than the set time difference TS. Specifically, the reachable value of the pressure parameter is set at the intermediate value instead of the threshold value.

This allows the value of the pressure parameter to reach the threshold value only in the case where the approach distance between the moving objects OB1 and OB2 is small as shown in FIG. 11A, whereby the action change event in which the driver of the moving object OB2 fails in the operation is generated. The value of the pressure parameter does not reach the threshold value when the moving object OB1 is not very close to the moving object OB2 as shown in FIG. 11B, whereby the action change event of the moving object OB2 is not generated. This enables a situation in which the player gets an unnatural impression to be prevented.

The intermediate set time difference TSM may be set at a value half of the set time difference TS. However, the intermediate set time difference TSM may be set at another value. The intermediate value may be set at a value half of the threshold value. However, the intermediate value may be set at another value. A plurality of intermediate values may be set.

2.8 Distance Range in Front and Behind

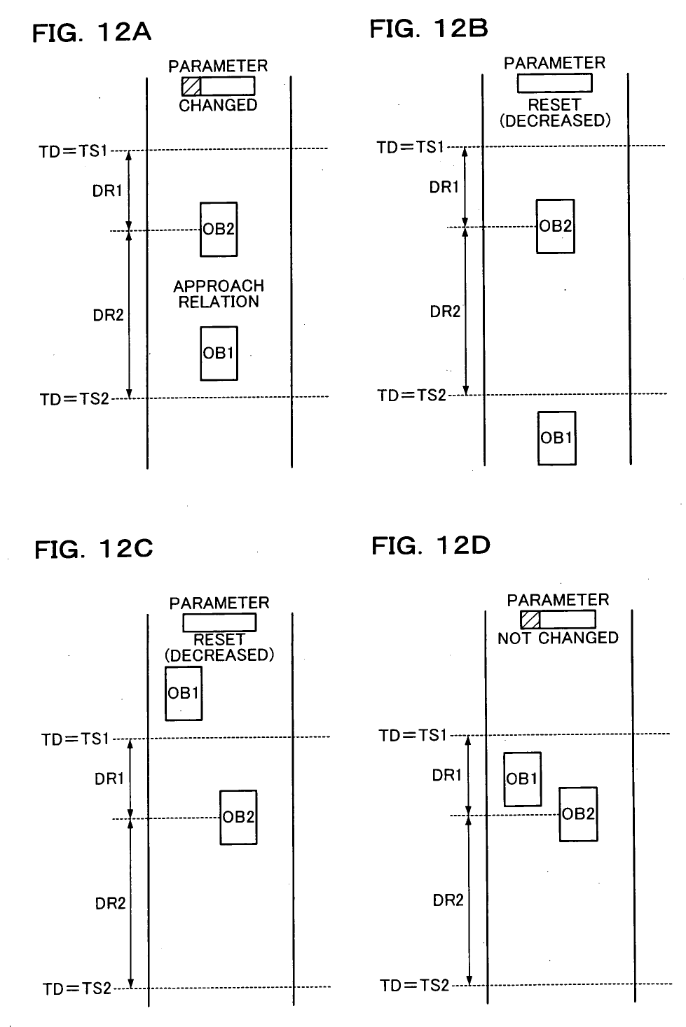

In FIGS. 10A to 10D, the distance range DR for realizing the pseudo time difference is set behind the moving object OB2. However, the distance range DR may also be set in front of the moving object OB2. In FIG. 12A, a first distance range DR1 (first time difference TS1) is set in front of the moving object OB2, and a second distance range DR2 (second time difference TS2) is set behind the moving object OB2.

The reset (decrease) processing of the pressure parameter is performed as described with reference to FIGS. 6A and 6B when the moving object OB1 is positioned outside the distance ranges DR1 and DR2 respectively set in front of and behind the moving object OB2 as shown in FIGS. 12B and 12C.

As shown in FIG. 12D, the reset (decrease) processing is not performed when the moving object OB1 is positioned in the distance range DR1 set in front of the moving object OB2, and the pressure parameter is maintained without being changed from the previous value.

Specifically, the state in which the moving object OB1 is positioned in the distance range DR1 in front of the moving object OB2 is a state in which the moving object OB1 which has run after the moving object OB2 passes the moving object OB2 and runs in front of the moving object OB2. In the case where the speed of the moving object OB1 does not differ from the speed of the moving object OB2 to a large extent, the moving object OB1 remains the target of competition of the moving object OB2, and the moving object OB2 may pass the moving object OBI. Therefore, the player gets an unnatural impression if the pressure parameter of the moving object OB2 is reset in this state.

Therefore, in the case where the moving object OB1 has passed the moving object OB2 and is positioned in the distance range DR1 in front of the moving object OB2 as shown in FIG. 12D, the pressure parameter is not reset and remains unchanged. This enables the state in which the moving object OB1 applies pressure to the moving object OB2 to be maintained, whereby a battle caused by the competition between the moving objects OB1 and OB2 continues.

The distance ranges DR1 and DR2 may be distance ranges which increase as the speed of the moving object OB2 increases in the same manner as in FIGS. 10A and 10B. This enables the approach relation to be determined based on the pseudo time difference instead of determining the approach relation merely based on the distance. It is preferable that the distance range DR1 be smaller than the distance range DR2. This enables the moving object OB1 which has moved away in front of the moving object OB2 to be excluded from the target of competition of the moving object OB2. In other words, the moving object OB1 can exclude the moving object OB2, which has moved away behind the moving object OB1, from the target of competition.

2.9 Change in Pressure Parameter Value Based on Movement (Offset) in Transverse Direction

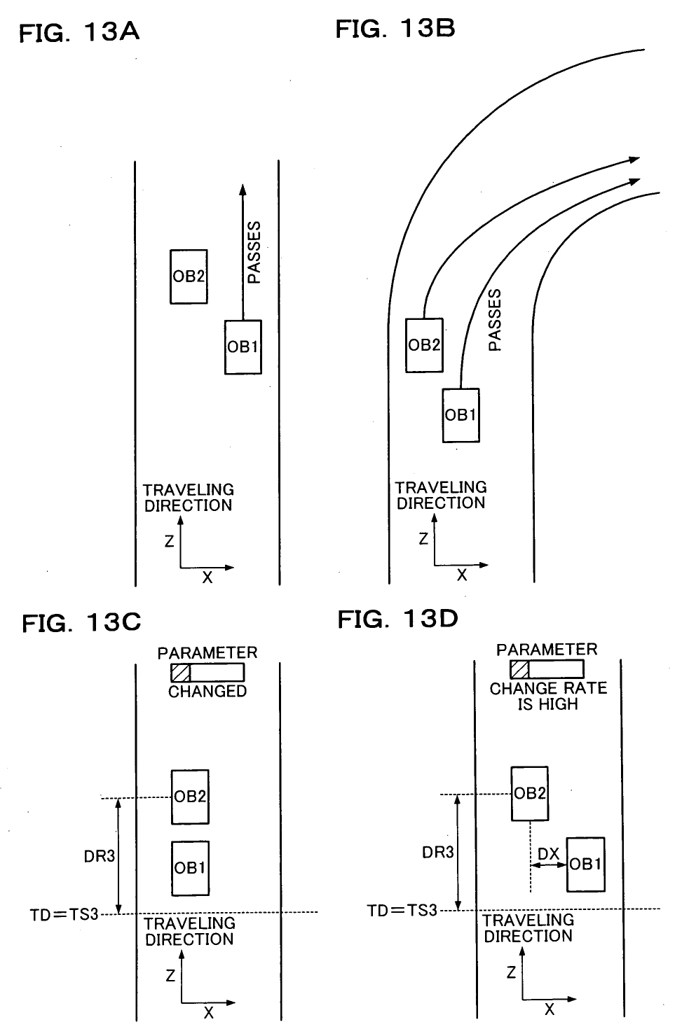

In the case where the moving object OB1 passes the moving object OB2 which runs ahead in a competition game, the moving object OB1 usually moves in the transverse direction and passes the moving object OB2 on the side, since the moving object OB1 collides with the moving object OB2 if the moving object OB1 approaches the moving object OB2 from directly behind. In the case where the moving object OB1 passes the moving object OB2 which runs along the traveling direction (Z direction) in the straight section of the course shown in FIG. 13A, the moving object OB1 moves in the transverse direction (X direction) which intersects the traveling direction at right angles, and then passes the moving object OB2. At the comer of the course shown in FIG. 13B, the moving object OB1 moves in the transverse direction (X direction) in order to run on the inner side of the moving object OB2, and then passes the moving object OB2. The driver of the moving object OB2 should feel the maximum pressure when the moving object OB1 reflected in the mirror moves in the transverse direction in order to pass the moving object OB2. In the present embodiment, the following method is employed to realize such a condition.

In FIG. 13C, a third distance range DR3 is set behind the moving object OB2 which runs along the traveling direction (Z direction), and the moving object OB1 is positioned within the third distance range DR3. The third distance range DR3 is smaller than the distance range DR2 shown in FIG. 12A. Therefore, the state shown in FIG. 13C in which the moving object OB1 is positioned in the distance range DR3 indicates a state in which the moving object OB1 is very close to the moving object OB2. The distance range DR3 indicates a pseudo time difference (TS3), and increases as the speed of the moving object OB2 increases.

In FIG. 13D, when the moving object OB1 is positioned within the distance range DR3, the value of the pressure parameter of the moving object OB2 is changed (increased) at a change rate which increases as the distance (relative distance) between the moving objects OB1 and OB2 increases in the direction (X direction) which intersects (crosses) the traveling direction (Z direction) at right angles. Specifically, in the present embodiment, the change rate of the pressure parameter increases as the distance (time difference) between the moving objects OB1 and OB2 decreases in the traveling direction, and the change rate of the pressure parameter increases as the distance between the moving objects OB1 and OB2 increases in the direction which intersects the traveling direction at right angles. This enables a situation in which the driver of the moving object OB2 feels pressure when the moving object OB1 reflected in the mirror moves in the transverse direction to be reproduced, whereby reality of the game can be increased.

In FIG. 13D, the change rate of the pressure parameter increases corresponding to the relative moving distance of the moving object OB1 in the X direction (transverse direction). However, in a competitive game involving airplanes or spacecraft, the change rate of the pressure parameter may be increased corresponding to the relative moving distance in the Y direction (longitudinal direction) which intersects the traveling direction (Z direction) at right angles.

The traveling direction is a direction along the course, for example. The traveling direction may be acquired from course information, for example. Specifically, the traveling direction and the course width at each point (each area) of the course and the position coordinates of each point are stored in the storage section as the course information while being associated with each point (each area) of the course. Therefore, the traveling direction can be acquired by reading the traveling direction information included in the course information associated with the point at which the moving object is positioned. Since the distance in the direction which intersects the traveling direction at right angles is calculated to check collision between the wall of the course or the like and the moving object, the change rate of the pressure parameter may be controlled based on the calculated distance. Whether or not the moving object OB1 is positioned in the distance range DR (DR1 to DR3) shown in FIGS. 10A to 10D and the like may be determined based on the course information. In more detail, the position coordinates (point number) of the course point corresponding to each of the moving objects OB1 and OB2 are acquired, the distance between the moving objects OB1 and OB2 is calculated based on the acquired position coordinates (point number), and whether or not the moving object OB1 is positioned within the distance range DR set behind the moving object OB2 is determined.

3. Processing of Present Embodiment

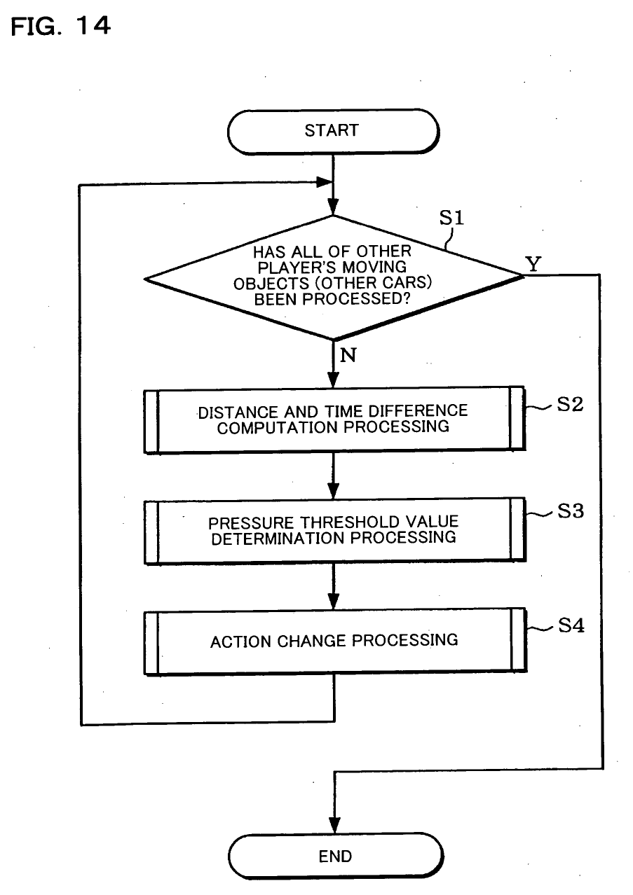

A detailed example of the processing of the present embodiment is described below by using flowcharts shown in FIGS. 14 to 19.

As shown in FIG. 14, whether or not all of other player's moving objects (moving objects operated by a computer player or another human player) are processed is determined (step S1). If another player's moving object which is not processed exists, the distance and time difference computation processing for this player's moving object is performed (step S2). The pressure threshold value determination processing for this player's moving object is then performed (step S3), and the action change processing is performed (step S4).

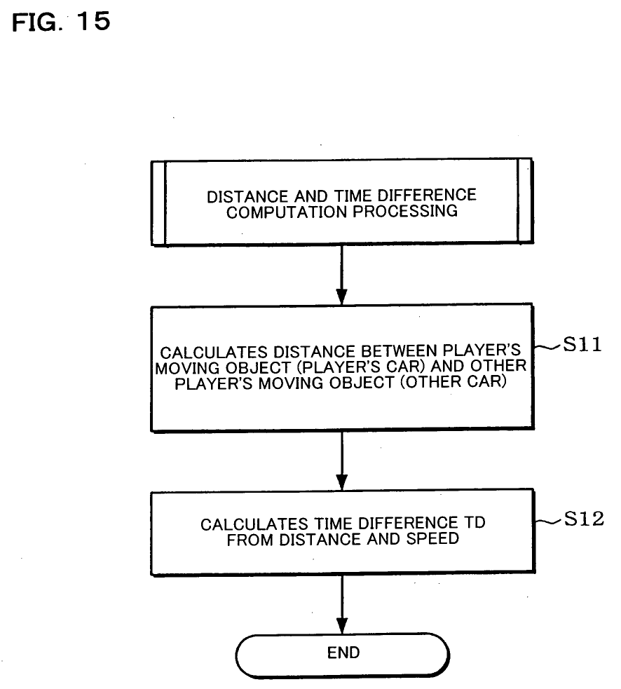

FIG. 15 is a flowchart of the distance and time difference computation processing in the step S2 shown in FIG. 14. The distance between the player's moving object (moving object operated by the player) and the other player's moving object is calculated (step S11). The distance may be a straight-line distance between the player's moving object and the other player's moving object, a distance along the course, or a distance in the direction of the depth.

The time difference TD is calculated from the distance and speed (step S12). For example, the time difference TD is calculated by dividing the distance obtained in the step S11 by the speed of the player's moving object. The time difference TD may be calculated while taking into consideration the acceleration of the player's moving object and the speed and acceleration of the other player's moving object in addition to the distance.

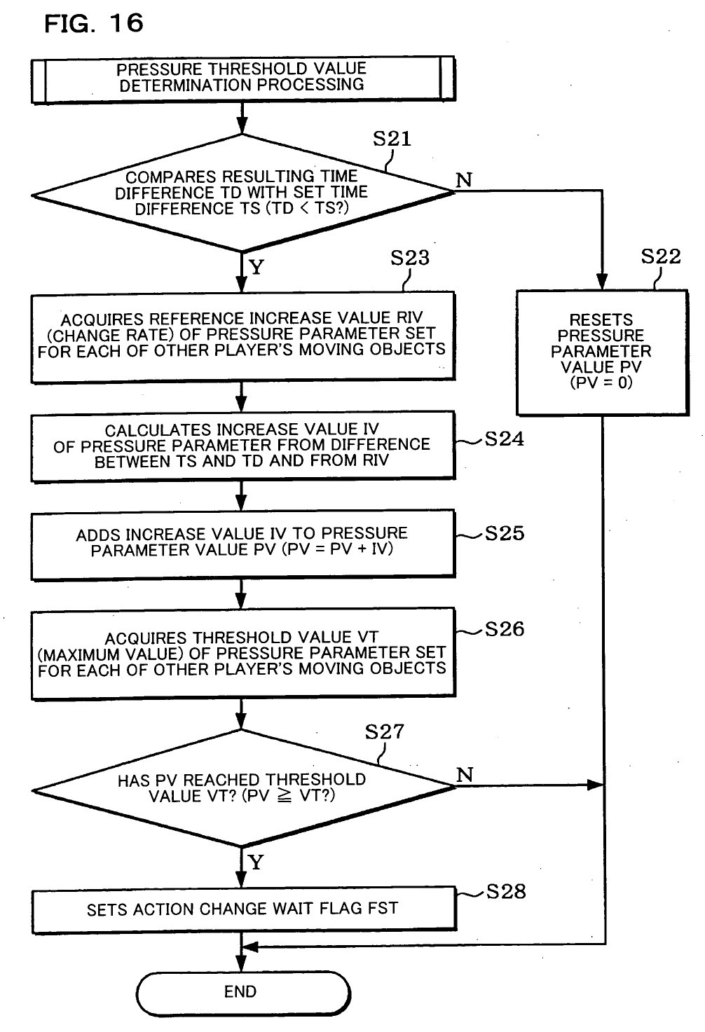

FIG. 16 is a flowchart of the pressure threshold value determination processing (parameter processing) in the step S3 shown in FIG. 14. The time difference TD obtained in the step S12 shown in FIG. 15 is compared with a given set time difference TS (reference time difference for determining the approach relation) (step S21). If TD≧TS, the pressure parameter value PV is reset as described with reference to FIGS. 6A and 6B (step S22). The pressure parameter value PV may be decreased at a high change rate.

If TD<TS, the reference increase value RIV (reference change rate in a broad sense) of the pressure parameter set for each of other player's moving objects is acquired as described with reference to FIGS. 4A to 5B (step S23). In more detail, the reference increase value RIV of the other player's moving object is acquired based on a table in which the other player's moving object is associated with the reference increase value.

The increase value IV (change rate in a broad sense) of the pressure parameter is calculated based on the difference between the given set time difference TS and the time difference TD and the reference increase value RIV (step S24). For example, the increase value IV is calculated so that the increase value IV has a greater value as the difference between the given set time difference TS and the time difference TD increases. This enables a phenomenon to be expressed in which the pressure increases as the time difference decreases.

The resulting increase value IV is added to the pressure parameter value PV (step S25). The threshold value VT (maximum value) of the pressure parameter set for each of other player's moving objects is acquired as described with reference to FIGS. 4A to 5B (step S26). In more detail, the threshold value VT of the other player's moving object is acquired based on a table in which the other player's moving object is associated with the threshold value.

Whether or not the pressure parameter value PV has reached the threshold value VT is determined (step S27). If the pressure parameter value PV has reached the threshold value VT, an action change wait flag FST is set (step S28).

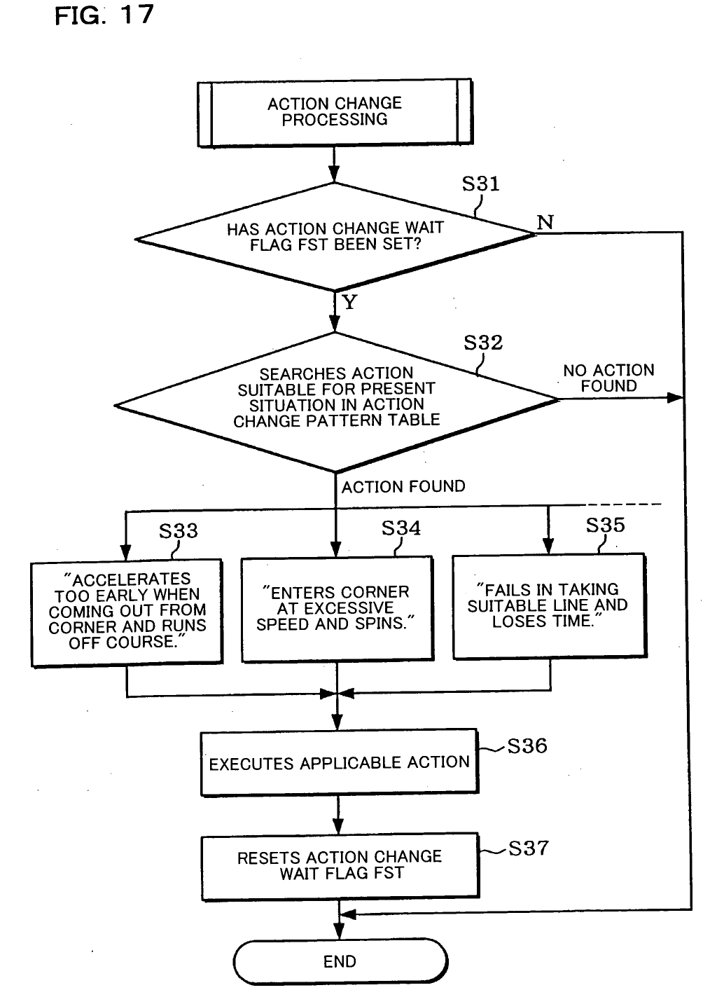

FIG. 17 is a flowchart of the action change processing in the step S4 shown in FIG. 14. Whether or not the action change wait flag FST has been set is determined (step S31). If the action change wait flag FST has been set, it is determined that the action change event has been generated, and the action suitable for the present situation is searched in an action change pattern table (step S32). For example, action in which the moving object accelerates too early when coming out from the comer and runs off the course (step S33), action in which the moving object enters the comer at an excessive speed and spins (step S34), action in which the moving object fails in taking a suitable line and loses time (step S35), or the like is selected. The selected action is executed (step S36), and the action change wait flag FST is reset (step S37).

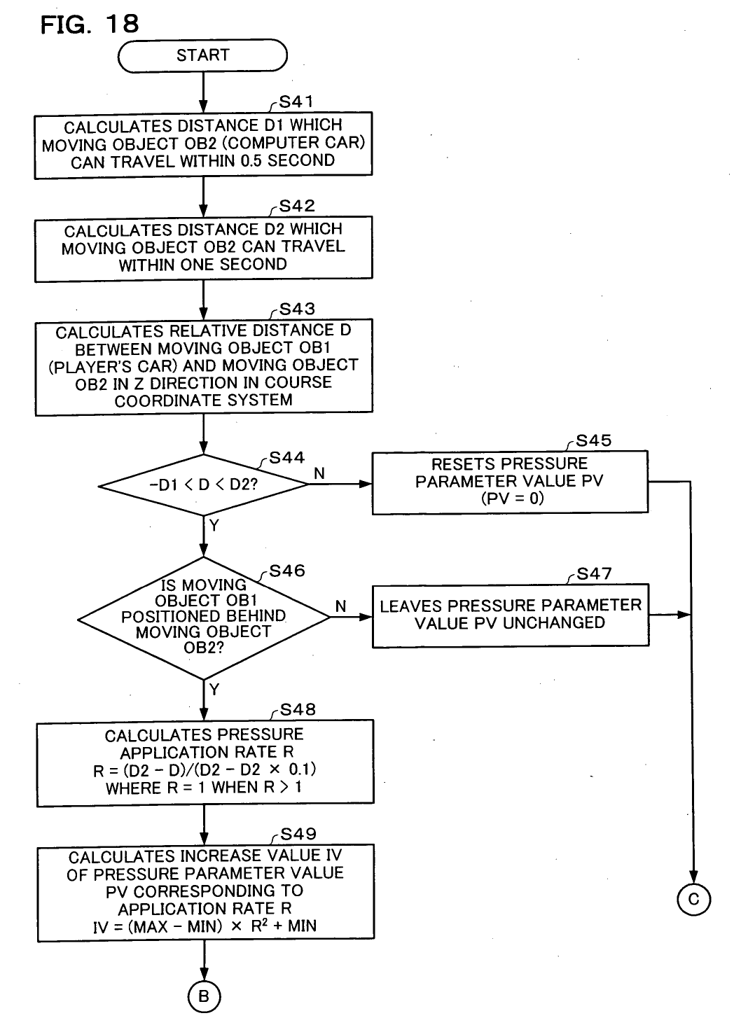

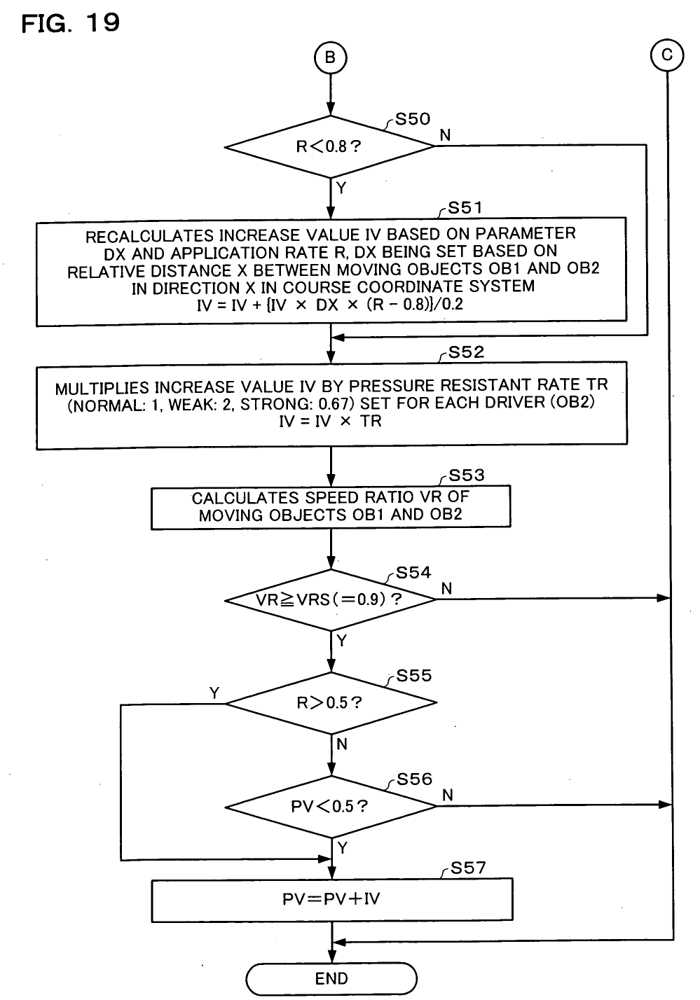

FIGS. 18 and 19 are flowcharts showing a detailed example of the determination processing of the approach relation based on the time difference. A distance D1 in which the moving object OB2 (computer car) can travel within 0.5 second is calculated (step S41). A distance D2 in which the moving object OB2 can travel within one second is calculated (step S42). The distances D1 and D2 respectively correspond to the distance ranges DR1 and DR2 shown in FIG. 12A.

A relative distance D between the moving object OB1 (player's car) and the moving object OB2 in the Z direction (traveling direction) in the course coordinate system (coordinate system of course information, distance coordinate system) is calculated (step S43). Whether or not the distance D is in the range of −D1<D<D2 is determined (step S44). If −D1<D<D2 is not satisfied, the pressure parameter value PV is reset (step S45), and the processing is terminated. If −D1<D<D2 is satisfied, whether or not the moving object OB1 is positioned behind the moving object OB2 is determined (step S46). If the moving object OB1 is positioned in front of the moving object OB2, the pressure parameter value PV is maintained without being changed (step S47), and the processing is terminated. The method described with reference to FIGS. 12A to 12D can be realized by the above-described processing.

A pressure application rate R is calculated (step S48). In more detail, the application rate R is calculated according to the following equation, for example.

R=(D2−D)/(D2−D2×0.1) (3)

where,

R=1 when R>1

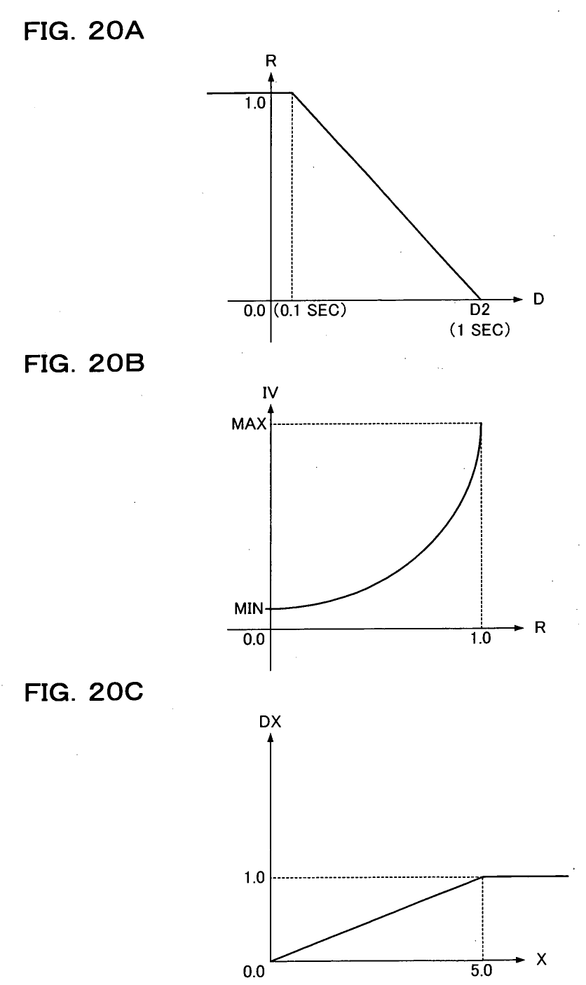

As shown in FIG. 20A, the application rate R is 0.0 when D=D2 (one second), and is 1.0 when D is 0.1 second or less. The degree of pressure applied to the driver of the moving object OB2 increases as the application rate R increases.

The increase value (increase amount) IV of the pressure parameter value PV corresponding to the application rate R is calculated (step S49). In more detail, the increase value IV is calculated according to the following equation, for example.

IV=(MAX−MIN)×R²+MIN (4)

As shown in FIG. 20B, the increase value IV has a minimum value MIN when R=0.0, and has a maximum value MAX when R=1.0. When the application rate R changes from 0.0 to 1.0, the increase value IV increases in proportion to R². This enables the increase value IV (change rate) of the pressure parameter value PV to be increased as the time difference between the moving objects OB1 and OB2 decreases (as the application rate R increases).

Whether or not the application rate R is greater than 0.8 is determined (step S50). If R>0.8, the increase value IV is recalculated based on a parameter DX, which is set based on the relative distance X between the moving objects OB1 and OB2 in the direction X in the course coordinate system, and based on the application rate R (step S51). In more detail, the increase value IV is recalculated according to the following equation, for example. The relationship between the distance X and the parameter DX is shown in FIG. 20C.

IV=IV+{IV×DX×(R−0.8)}/0.2 (5)

The increase value IV becomes twice the original value by the above recalculation when DX=1.0 and R=1.0, for example, whereby the method described with reference to FIGS. 13A to 13D can be realized.

The increase value IV (change rate) is multiplied by a pressure resistant rate TR (normal: 1, weak: 2, strong: 0.67) set for each driver (OB2) (step S52). This enables the method described with reference to FIGS. 5A and 5B to be realized.

The ratio VR of the speed V1 of the moving object OB1 to the speed V2 of the moving object OB2 (V1/V2) is calculated (step S53). Then, whether or not the speed ratio VR is equal to or greater than the set ratio VRS is determined (step S54). The set ratio VRS may be set at 0.9. If VR<VRS, the processing is terminated without adding the increase value IV to the pressure parameter value PV (step S57). The method described with reference to FIGS. 10C and 10D can be realized by the above-described processing.

If VR>VRS, whether or not the application rate R is greater than 0.5 (application rate corresponding to the intermediate set time difference) is determined (step S55). If R>0.5, the increase value IV is added to the pressure parameter value PV (PV=PV+IV) (step S57). If R<0.5, whether or not the pressure parameter value PV is smaller than 0.5 (intermediate value) is determined (step S56). If PV<0.5, the increase value IV is added to the pressure parameter value PV (step S57). If PV>0.5, the processing is terminated without adding the increase value IV to the pressure parameter value PV (step S57). The method described with reference to FIGS. 11A and 11B can be realized by the above-described processing.

4. Hardware Configuration

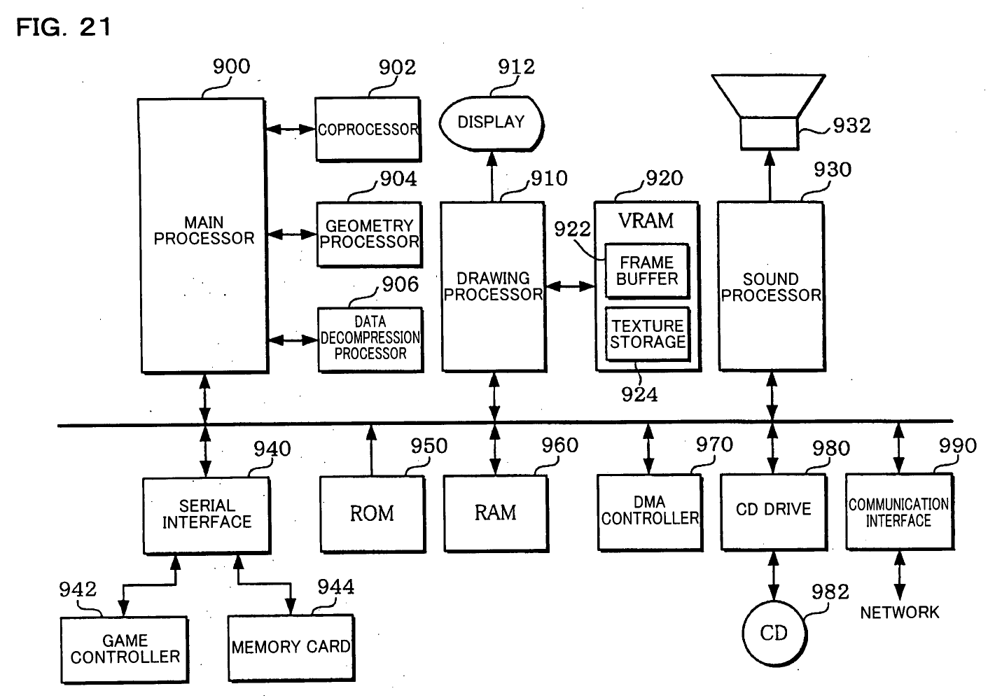

An example of a hardware configuration capable of realizing the present embodiment is described below with reference to FIG. 21.

A main processor 900 operates based on a program stored in a CD 982 (information storage medium), a program transferred through a communication interface 990, or a program stored in a ROM 950 (one of information storage media), and performs various types of processing such as game processing, image processing, and sound processing.

A coprocessor 902 assists the processing of the main processor 900. The coprocessor 902 includes a product sum calculator and a divider capable of performing a high-speed parallel computation, and performs a matrix computation (vector computation) at high speed. In the case where processing such as a matrix computation is necessary for physical simulation to allow the object to move or take motion, the program which operates on the main processor 900 instructs (requests) the coprocessor 902 to perform the processing.

A geometry processor 904 performs geometry processing such as coordinate transformation, perspective transformation, light source calculation, and curved surface generation. The geometry processor 904 includes a product sum calculator and a divider capable of performing a high-speed parallel computation, and performs a matrix computation (vector computation) at high speed. In the case of performing the processing such as coordinate transformation, perspective transformation, or light source calculation, the program which operates on the main processor 900 instructs the geometry processor 904 to perform the processing.

A data decompression processor 906 performs decode processing of decompressing compressed image data or sound data, or processing of accelerating the decode processing of the main processor 900. This enables a motion picture compressed according to the MPEG standard or the like to be displayed in an opening screen, intermission screen, ending screen, or game screen. The image data or sound data to be subjected to the decode processing is stored in the ROM 950 or CD 982, or transferred from the outside through the communication interface 990.

A drawing processor 910 performs drawing (rendering) processing of an object consisting of a primitive (primitive surface) such as a polygon or a curved surface at high speed. In the case of drawing the object, the main processor 900 delivers object data to the drawing processor 910 by utilizing the function of a DMA controller 970, and transfers a texture to a texture storage section 924, if necessary. The drawing processor 910 draws the object in a frame buffer 922 at high speed based on the object data and the texture while performing hidden surface removal by utilizing a Z buffer or the like. The drawing processor 910 also performs a blending (translucent processing), depth queuing, MIP mapping, fog processing, bilinear filtering, trilinear filtering, anti-aliasing, and shading processing. If the image for one frame is written in the frame buffer 922, the image is displayed in the display 912.

A sound processor 930 includes a multi-channel ADPCM sound source, and generates high-quality game sound such as BGM, effect sound, and voice. The game sound generated is output from a speaker 932.

Operation data from a game controller 942 (lever, button, casing, pad-type controller or gun-type controller, and the like) and saved data and personal data from a memory card 944 are transferred through a serial interface 940.

A system program and the like are stored in the ROM 950. In the case of an arcade game system, the ROM 950 functions as the information storage medium and stores various programs. A hard disk may be used instead of the ROM 950.

A RAM 960 is used as a work area for various processors.

The DMA controller 970 controls DMA transfer between the processors and the memory (RAM, VRAM, ROM, and the like).

A CD drive 980 drives the CD 982 (information storage medium) in which the program, image data, or sound data is stored to enable access to the program and the data.

The communication interface 990 is an interface for performing data transfer with the outside through a network. In this case, as the network connected with the communication interface 990, a communication line (analog telephone line or ISDN) or a high-speed serial bus may be utilized. Data transfer through the Internet can be achieved by utilizing the communication line. Data transfer with other image generation systems can be achieved by utilizing the high-speed serial bus.

Each section (each means) of the present embodiment may entirely be realized by only hardware, or by only a program stored in the information storage medium or a program distributed through the communication interface. Each section of the present embodiment may be realized by hardware and a program.

In the case of realizing each section of the present embodiment by hardware and a program, a program for causing hardware (computer) to function as each section of the present embodiment is stored in the information storage medium. In more detail, the above program instructs the processors 902, 904, 906, 910, and 930 (hardware) to perform processing, and transfers data if necessary. Each of the processors 902, 904, 906, 910, and 930 realizes each section of the present invention based on the instruction and the transferred data.

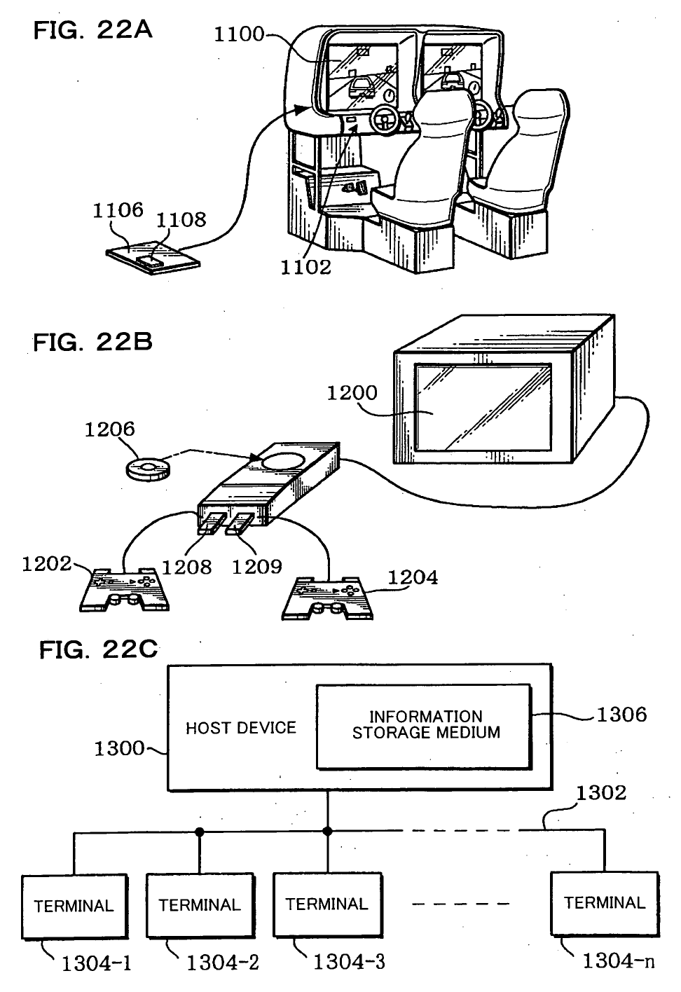

FIG. 22A shows an example in the case where the present embodiment is applied to an arcade game system (image generation system). A player enjoys the game by operating an operating section 1102 (lever and button) while watching a game image displayed on a display 1100. Various processors and memories are mounted on a built-in system board (circuit board) 1106. A program (data) for realizing each section of the present embodiment is stored in a memory 1108 (information storage medium) on the system board 1106. This program is hereinafter called a stored program (stored information).

FIG. 22B shows an example in the case where the present embodiment is applied to a consumer game system (image generation system). A player enjoys the game by operating controllers 1202 and 1204 while watching a game image displayed on a display 1200. In this case, the above stored program (stored information) is stored in a CD 1206 or memory cards 1208 and 1209, which are information storage media removable from the main body of the system.

FIG. 22C shows an example in the case where the present embodiment is applied to a system which includes a host device 1300 and terminals 1304-1 to 1304-n (game devices or portable telephones) which are connected with the host device 1300 through a network 1302 (small-scale network such as a LAN or wide area network such as the Internet). In this case, the above stored program (stored information) is stored in an information storage medium 1306 such as a magnetic disk device, a magnetic tape device, or a memory which can be controlled by the host device 1300, for example. In the case where the terminals 1304-1 to 1304-n can generate the game image and game sound by themselves, a game program for generating the game image and game sound is transferred to the terminals 1304-1 to 1304-n from the host device 1300. In the case where the terminals 1304-1 to 1304-n cannot generate the game image and game sound by themselves, the host device 1300 generates the game image and game sound and transfers the game image and game sound to the terminals 1304-1 to 1304-n. The terminals 1304-1 to 1304-n output the transferred game image and game sound.

In the case of the configuration shown in FIG. 22C, each section of the present embodiment may be distributed and realized by the host device (server) and the terminal. The above stored program (stored information) for realizing each section of the present embodiment may be distributed and stored in the information storage medium of the host device (server) and the information storage medium of the terminal.

The terminal connected with the network may be a consumer game system or an arcade game system.

The present invention is not limited to the above embodiment. Various modifications and variations are possible.

The terms (pressure parameter, pressure meter, movement or motion, operation failure, increase value, reference increase value, and the like) cited in the description in the specification or the drawings as the terms in a broad sense (first parameter, parameter display object, action, action change, change rate, reference change rate, and the like) may be replaced by the terms in a broad sense in another description in the specification or the drawings.

The present embodiment is described taking the approach relation (position relation) as an example of the relation by which pressure is applied. However, the relation by which pressure is applied may be a relation other than the approach relation. For example, whether or not the first moving object and the second moving object have a relation in which the first moving object applies pressure to the second moving object may be determined based on a given relation determined based on at least one of the position (direction) information, speed information, and acceleration information.

The determination method of the approach (pressure) relation, the display method of the parameter display object, the processing method of the parameter, the generation method of the action change event, and the like are not limited to the methods described in the present embodiment. Various modifications and variations are possible.

Part of requirements of any claim of the present invention could be omitted from a dependent claim which depends on that claim. Moreover, part of requirements of any independent claim of the present invention could be made to depend on any other independent claim.

The present invention may be applied to various games (fighting game, competitive game, shooting game, robot fighting game, sport game, role playing game, and the like).

The present invention may be applied to various image generation systems (game systems) such as an arcade game system, consumer game system, large-scale attraction system in which a number of players participate, simulator, multimedia terminal, and system board which generates a game image.

The following items are disclosed relating to the configuration of the above-described embodiment.

One embodiment of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

determining that the first and second moving objects have been in the approach relation when a time difference between the first and second moving objects becomes smaller than a given set time difference.

In this image generation method, the value of the first parameter changes when the first and second moving objects are in an approach relation, and the action change event (event for changing the action) of the second moving object is generated when the value of the first parameter reaches the threshold value. This enables the level of virtual reality considering the psychological factor and the like to be increased. In this image generation method, the approach relation is determined based on the time difference between the first and second moving objects. This prevents a situation in which it is determined that the first and second moving objects are not in an approach relation although the time difference is small for the reason that the distance between the first and second moving objects is long since the speed of the first and second moving objects is high. This also prevents a situation in which it is determined that the first and second moving objects are in an approach relation although the time difference is large for the reason that the distance between the first and second moving objects is short since the speed of the first and second moving objects is low. Therefore, a determination method of the approach relation which rarely causes the player to get an unnatural impression in comparison with a method of determining the approach relation merely based on the distance or time can be provided.

The approach relation may be determined taking speed information or acceleration information of the moving objects into consideration, in addition to position information (position relation, direction relation) of the moving objects. The action change event may be realized by changing action control (movement control or motion control) of the second moving object or changing a parameter (parameter other than the first parameter; such as action control parameter or ability parameter) of the second moving object, for example.

In this image generation method, the time difference between the first and second moving objects may be determined to be smaller than the given set time difference when the first moving object is positioned within a given distance range which increases as a speed of the second moving object increases. The processing load can be reduced by determining the approach relation based on such a pseudo time difference.

In this image generation method, the value of the first parameter of the second moving object may be changed when the first moving object is positioned within the given distance range which increases as the speed of the second moving object increases and a ratio of a speed of the first moving object to the speed of the second moving object is equal to or greater than a given set ratio. This enables the approach relation to be determined while taking the speed of the first moving object into consideration, whereby the approach relation can be determined based on the determination standard close to that when using the time difference in a strict sense while using the pseudo time difference.

In this image generation method, the value of the first parameter of the second moving object may be changed at a higher change rate as the time difference between the first and second moving objects decreases.

In this image generation method, the value of the first parameter of the second moving object may be changed up to the threshold value when the time difference between the first and second moving objects is smaller than an intermediate set time difference which is smaller than the given set time difference, and the value of the first parameter of the second moving object may be changed up to an intermediate value which is smaller than the threshold value when the time difference between the first and second moving objects is greater than the intermediate set time difference and is smaller than the given set time difference. This prevents the value of the first parameter from reaching the threshold value when the first moving object is not very close to the second moving object, whereby the action change is not generated. This enables a determination method of the approach relation which rarely causes the player to get an unnatural impression to be provided.

Another embodiment of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

resetting or decreasing the value of the first parameter of the second moving object which has changed due to the approach relation, when the first moving object is positioned outside first and second distance ranges which are set in front of and behind the second moving object, respectively, and leaving the value of the first parameter unchanged when the first moving object is positioned in the first distance range which is set in front of the second moving object.

According to this image generation method, the processing of resetting or decreasing the value of the first parameter is performed when the first moving object is positioned outside the first and second distance ranges. The reset or decrease processing is not performed when the first moving object is positioned in the first distance range in front of the second moving object, and the value of the first parameter is maintained without being changed. Therefore, the competition between the first and second moving objects can be allowed to continue when the first moving object is positioned in the first distance range in front of the second moving object.

In this image generation method, the first and second distance ranges may be distance ranges which increase as a speed of the second moving object increases.

A further embodiment of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

changing the value of the first parameter of the second moving object at a higher change rate as a distance between the first and second moving objects increases in a direction which intersects a traveling direction at right angles when the first moving object is positioned in a third distance range which is set behind the second moving object.

According to this image generation method, when the first moving object is positioned in the third distance range, the value of the first parameter changes at a change rate corresponding to the distance in the direction (transverse direction or longitudinal direction) which intersects the traveling direction at right angles. Therefore, the change rate of the first parameter increases when the first moving object moves in the direction which intersects the traveling direction at right angles, whereby the action change event of the second moving object is generated earlier. This enables a realistic competitive game to be realized.

In this image generation method, the third distance range may be a distance range which increases as a speed of the second moving object increases.

A still further embodiment of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation;

generating an action change event in which action of the second moving object changes when it is determined that the value of the first parameter of the second moving object has reached a threshold value; and

performing processing of displaying a parameter display object which visually indicates a change in the value of the first parameter of the second moving object.

In this image generation method, the value of the first parameter changes when the first and second moving objects are in an approach relation, and the action change event (event for changing the action) of the second moving object is generated when the value of the first parameter reaches the threshold value. This enables the level of virtual reality considering the psychological factor and the like to be increased. In this image generation method, the value of the first parameter changes when the first and second moving objects are in an approach relation, and the parameter display object which visually indicates the change in the value of the first parameter is displayed. This enables the player to visually recognize the value of the first parameter which changes due to the approach relation.

The shape of the parameter display object is arbitrary. The parameter display object may be disposed in the object space, or displayed (disposed) on a two-dimensional screen as a sprite.

In this image generation method, when a plurality of the second moving objects move in the object space, at least one of the threshold value and a change rate of the first parameter may be set for each of the second moving objects. When at least one of the threshold value and the change rate is allowed to differ for each of the second moving objects, at least one of the shape and the color (properties) of the parameter display object which visually indicates the change in the value of the first parameter may be allowed to differ for each of the second moving objects.

In this image generation method, at least one of the threshold value and the change rate of the first parameter of each of the second moving objects may be set according to a relative relation between the first moving object and each of the second moving objects. The relative relation used herein refers to a relation such as the difference in ability or difference in type between the moving objects, for example.

In this image generation method, a length of the parameter display object may be increased as the threshold value of the first parameter set for each of the second moving objects is greater, the parameter display object being displayed associating with each of the second moving objects. This enables the player to easily know the degree of change in the first parameter which causes the action change event of the second moving object to be generated by watching the length of the parameter display object.

A still further embodiment of the present invention relates to an image generation method for generating an image, including:

performing processing of moving first and second moving objects in an object space;

generating an image viewed from a given viewpoint in the object space;

performing processing of changing a value of a first parameter of the second moving object when it is determined that the first moving object and the second moving object have been in an approach relation; and

performing processing of displaying a parameter display object which visually indicates a change in the value of the first parameter of the second moving object.

In this image generation method, the value of the first parameter changes when the first and second moving objects are in an approach relation, and the parameter display object which visually indicates the change in the value of the first parameter is displayed. This enables the player to visually recognize the value of the first parameter which changes due to the approach relation.

This image generation method may include performing processing of displaying the parameter display object associating with each of the second moving objects when a plurality of the second moving objects move in the object space, the parameter display object visually indicating the change in the value of the first parameter of each of the second moving objects.

In this image generation method, the first parameter of the second moving object may be a pressure parameter which virtually indicates a degree of pressure applied to the second moving object. The first parameter is not limited to the pressure parameter. For example, another parameter which indicates the psychological factor or the like may be employed as the first parameter.

The above image generation method may include changing game sound to be output according to the change in the value of the first parameter. The game sound to be changed is background music (BGM), effect sound, voice, or the like. The game sound may be changed by changing at least one of the volume, tempo, and tone of the game sound, or changing the game sound to a different type of game sound (music). The game sound may be changed when the action change event is generated.

What is claimed is:

1. An image generation method for generating an image, comprising:
performing processing of moving first and second moving objects in an object space;
generating an image viewed from a given viewpoint in the object space;
performing processing of changing a value of a first parameter of the second moving object when it is determined that the first moving object and the second moving object have been in an approach relation;
generating an action change event in which action of the second moving object changes when it is determined that the value of the first parameter of the second moving object has reached a threshold value; and
determining that the first and second moving objects have been in the approach relation when a time difference between the first and second moving objects becomes smaller than a given set time difference.

2. The image generation method as defined in claim 1,
wherein the time difference between the first and second moving objects is determined to be smaller than the given set time difference when the first moving object is positioned within a given distance range which increases as a speed of the second moving object increases.

3. The image generation method as defined in claim 2,
wherein the value of the first parameter of the second moving object is changed when the first moving object is positioned within the given distance range which increases as the speed of the second moving object increases and a ratio of a speed of the first moving object to the speed of the second moving object is equal to or greater than a given set ratio.

4. The image generation method as defined in claim 1,
wherein the value of the first parameter of the second moving object is changed at a higher change rate as the time difference between the first and second moving objects decreases.

5. The image generation method as defined in claim 1,
wherein the value of the first parameter of the second moving object is changed up to the threshold value when the time difference between the first and second moving objects is smaller than an intermediate set time difference which is smaller than the given set time difference, and the value of the first parameter of the second moving object is changed up to an intermediate value which is smaller than the threshold value when the time difference between the first and second moving objects is greater than the intermediate set time difference and is smaller than the given set time difference.

6. An image generation method for generating an image, comprising:
performing processing of moving first and second moving objects in an object space;
generating an image viewed from a given viewpoint in the object space;
performing processing of changing a value of a first parameter of the second moving object when it is determined that the first moving object and the second moving object have been in an approach relation;
generating an action change event in which action of the second moving object changes when it is determined that the value of the first parameter of the second moving object has reached a threshold value; and
resetting or decreasing the value of the first parameter of the second moving object which has changed due to the approach relation, when the first moving object is positioned outside first and second distance ranges which are set in front of and behind the second moving object, respectively, and leaving the value of the first parameter unchanged when the first moving object is positioned in the first distance range which is set in front of the second moving object.

7. The image generation method as defined in claim 6,
wherein the first and second distance ranges are distance ranges which increase as a speed of the second moving object increases.

8. An image generation method for generating an image, comprising:
performing processing of moving first and second moving objects in an object space;
generating an image viewed from a given viewpoint in the object space;
performing processing of changing a value of a first parameter of the second moving object when it is determined that the first moving object and the second moving object have been in an approach relation;
generating an action change event in which action of the second moving object changes when it is determined that the value of the first parameter of the second moving object has reached a threshold value; and
changing the value of the first parameter of the second moving object at a higher change rate as a distance between the first and second moving objects increases in a direction which intersects a traveling direction at right angles when the first moving object is positioned in a third distance range which is set behind the second moving object.

9. The image generation method as defined in claim 8,
wherein the third distance range is a distance range which increases as a speed of the second moving object increases.

10. An image generation method for generating an image, comprising:
performing processing of moving first and second moving objects in an object space;
generating an image viewed from a given viewpoint in the object space;
performing processing of changing a value of a first parameter of the second moving object when it is determined that the first moving object and the second moving object have been in an approach relation;
generating an action change event in which action of the second moving object changes when it is determined that the value of the first parameter of the second moving object has reached a threshold value; and
performing processing of displaying a parameter display object which visually indicates a change in the value of the first parameter of the second moving object.

11. The image generation method as defined in claim 1,
wherein, when a plurality of the second moving objects move in the object space, at least one of the threshold value and a change rate of the first parameter is set for each of the second moving objects.

12. The image generation method as defined in claim 10,
wherein, when a plurality of the second moving objects move in the object space, at least one of the threshold value and a change rate of the first parameter is set for each of the second moving objects.

13. The image generation method as defined in claim 11,
wherein at least one of the threshold value and the change rate of the first parameter of each of the second moving objects is set according to a relative relation between the first moving object and each of the second moving objects.

14. The image generation method as defined in claim 12,
wherein a length of the parameter display object is increased as the threshold value of the first parameter set for each of the second moving objects is greater, the parameter display object being displayed associating with each of the second moving objects.

15. An image generation method for generating an image, comprising:
performing processing of moving first and second moving objects in an object space;
generating an image viewed from a given viewpoint in the object space;
performing processing of changing a value of a first parameter of the second moving object when it is determined that the first moving object and the second moving object have been in an approach relation; and
performing processing of displaying a parameter display object which visually indicates a change in the value of the first parameter of the second moving object.

16. The image generation method as defined in claim 15, comprising:
when a plurality of the second moving objects move in the object space, performing processing of displaying the parameter display object associating with each of the second moving objects, the parameter display object visually indicating the change in the value of the first parameter of each of the second moving objects.

17. The image generation method as defined in claim 1,
wherein the first parameter of the second moving object is a pressure parameter which virtually indicates a degree of pressure applied to the second moving object.

18. The image generation method as defined in claim 6,
wherein the first parameter of the second moving object is a pressure parameter which virtually indicates a degree of pressure applied to the second moving object.

19. The image generation method as defined in claim 8,
wherein the first parameter of the second moving object is a pressure parameter which virtually indicates a degree of pressure applied to the second moving object.

20. The image generation method as defined in claim 10,
wherein the first parameter of the second moving object is a pressure parameter which virtually indicates a degree of pressure applied to the second moving object.

21. The image generation method as defined in claim 15,
wherein the first parameter of the second moving object is a pressure parameter which virtually indicates a degree of pressure applied to the second moving object.

22. The image generation method as defined in claim 1, comprising:
changing game sound to be output according to the change in the value of the first parameter.

23. The image generation method as defined in claim 6, comprising:
changing game sound to be output according to the change in the value of the first parameter.

24. The image generation method as defined in claim 8, comprising:
changing game sound to be output according to the change in the value of the first parameter.

25. The image generation method as defined in claim 10, comprising:
changing game sound to be output according to the change in the value of the first parameter.

26. The image generation method as defined in claim 15, comprising:
changing game sound to be output according to the change in the value of the first parameter.

27. A program for generating an image, the program causing a computer to function as:
a movement processing section which performs processing of moving first and second moving objects in an object space;
an image generation section which generates an image viewed from a given viewpoint in the object space;
a parameter processing section which performs processing of changing a value of a first parameter of the second moving object when it is determined that the first moving object and the second moving object have been in an approach relation; and
an action change processing section which generates an action change event in which action of the second moving object changes when it is determined that the value of the first parameter of the second moving object has reached a threshold value;
wherein the parameter processing section determines that the first and second moving objects have been in the approach relation when a time difference between the first and second moving objects becomes smaller than a given set time difference.

28. A program for generating an image, the program causing a computer to function as:
a movement processing section which performs processing of moving first and second moving objects in an object space;
an image generation section which generates an image viewed from a given viewpoint in the object space;
a parameter processing section which performs processing of changing a value of a first parameter of the second moving object when it is determined that the first moving object and the second moving object have been in an approach relation; and
an action change processing section which generates an action change event in which action of the second moving object changes when it is determined that the value of the first parameter of the second moving object has reached a threshold value;
wherein the parameter processing section resets or decreases the value of the first parameter of the second moving object which has changed due to the approach relation, when the first moving object is positioned outside first and second distance ranges which are set in front of and behind the second moving object, respectively, and leaves the value of the first parameter unchanged when the first moving object is positioned in the first distance range which is set in front of the second moving object.

29. A program for generating an image, the program causing a computer to function as:
a movement processing section which performs processing of moving first and second moving objects in an object space;
an image generation section which generates an image viewed from a given viewpoint in the object space;
a parameter processing section which performs processing of changing a value of a first parameter of the second moving object when it is determined that the first moving object and the second moving object have been in an approach relation; and
an action change processing section which generates an action change event in which action of the second moving object changes when it is determined that the value of the first parameter of the second moving object has reached a threshold value;
wherein the parameter processing section changes the value of the first parameter of the second moving object at a higher change rate as a distance between the first and second moving objects increases in a direction which intersects a traveling direction at right angles when the first moving object is positioned in a third distance range which is set behind the second moving object.

30. A program for generating an image, the program causing a computer to function as:
a movement processing section which performs processing of moving first and second moving objects in an object space;
an image generation section which generates an image viewed from a given viewpoint in the object space;
a parameter processing section which performs processing of changing a value of a first parameter of the second moving object when it is determined that the first moving object and the second moving object have been in an approach relation;
an action change processing section which generates an action change event in which action of the second moving object changes when it is determined that the value of the first parameter of the second moving object has reached a threshold value; and
a parameter display processing section which performs processing of displaying a parameter display object which visually indicates a change in the value of the first parameter of the second moving object.

31. A program for generating an image, the program causing a computer to function as:
a movement processing section which performs processing of moving first and second moving objects in an object space;
an image generation section which generates an image viewed from a given viewpoint in the object space;
a parameter processing section which performs processing of changing a value of a first parameter of the second moving object when it is determined that the first moving object and the second moving object have been in an approach relation; and
a parameter display processing section which performs processing of displaying a parameter display object which visually indicates a change in the value of the first parameter of the second moving object.

32. A computer-readable information storage medium in which the program as defined in claim 27 is stored.

33. A computer-readable information storage medium in which the program as defined in claim 28 is stored.

34. A computer-readable information storage medium in which the program as defined in claim 29 is stored.

35. A computer-readable information storage medium in which the program as defined in claim 30 is stored.

36. A computer-readable information storage medium in which the program as defined in claim 31 is stored.
